(19) United States
(12) Patent Application Publication
(10) Pub. No.: US 2024/0335783 A1
(43) Pub. Date: Oct. 10, 2024

(54) LARGE-SCALE INTEGRATED DEVICE OF CO2 CAPTURE, SEQUESTRATION AND UTILIZATION

(71) Applicant: DALIAN UNIVERSITY OF TECHNOLOGY, Dalian (CN)

(72) Inventors: Yongchen SONG, Dalian (CN); Lanlan JIANG, Dalian, Liaoning (CN); Mingjun YANG, Dalian (CN); Bingbing CHEN, Dalian (CN); Yu LIU, Dalian (CN); Jing CHEN, Dalian (CN)

(21) Appl. No.: 18/587,403

(22) Filed: Feb. 26, 2024

(30) Foreign Application Priority Data
Apr. 10, 2023 (CN) 202310375893.7

(51) Int. Cl. B01D 53/00; B01D 53/62

(52) U.S. Cl. CPC B01D 53/002; B01D 53/62

(57) ABSTRACT

The present invention belongs to the application field of hydrate technology, and discloses a large-scale integrated device of CO₂ capture, sequestration and utilization and method. The device separates and purifies CO₂ in a forward or reverse way; at the same time, it is configured with a storage simulation system to store the purified CO₂; the system is configured with an axial pressure and circumferential pressure system, which can simulate the pressure environment of the deep-sea ocean and provide experimental support for the storage of CO₂ in the deep-sea; and the device is reserved for the interface of seawater desalination system module, which can provide an experimental environment for the desalination of seawater by the hydrate method. Finally, the device is equipped with a cold storage system to realize the secondary utilization of energy from industrial high temperature exhaust gas.

### TECHNICAL FIELD

The present invention belongs to the field of hydrate technology application, and specifically relates to a large-scale integrated device of CO₂ capture, sequestration and utilization.

### BACKGROUND TECHNOLOGY

Carbon dioxide is an important substance that contributes to the greenhouse effect, and fossil fuels will continue to dominate the world's energy supply for decades to come, and carbon emission reduction continues to face a huge challenge as requirements for environmental protection increase.

Carbon capture and storage (CCS) technology is effective in capturing carbon dioxide from emission sources and then storing it permanently at a suitable site. However, this process carries a potential risk of leakage, coupled with the huge investment in long-distance transportation and high cost of production, so CCS has been expanded to include “utilization”, i.e., Carbon Capture and Utilization (CCUS), which seeks to find highly efficient and beneficial carbon dioxide capture-and-utilization technologies to replace traditional processes, creating direct or indirect benefits while saving energy and reducing carbon emissions.

CO₂ capture can be mainly categorized into biological, physical and chemical absorption methods. The biological absorption process is greatly affected by photosynthesis and requires a larger site and higher costs for centralized emission treatment in factories; the physical absorption method is mostly carried out at low temperatures and high pressures, with high energy consumption and technical requirements, and there are still limitations to its industrial application; the chemical absorption method requires additional drying steps and leads to serious corrosion of equipment, and the operation process is complicated, and improper treatment is likely to cause environmental problems.

The hydrate method of carbon capture technology utilizes the principle that binary and multiple gases generate hydrates with a large gap in phase equilibrium, so that gases that are more likely to form gas hydrates enter the hydrate phase, while gases that are difficult to form gas hydrates are retained in the gas phase, thus realizing the separation of mixed gases.

The hydrate separation process requires relatively mild reaction conditions, pressure and temperature are easier to realize in the chemical reaction process, and it is easier to control the energy consumption. Hydrate separation process will not produce secondary pollution, hydrate generation and separation process only need gas and water, unlike the traditional separation process will not produce waste and material loss. However, there are still problems such as slower hydrate generation, harder hydrate separation, etc. The research progress mainly stays in the laboratory scale, and the scale of pilot level is rare, and industrialization is even rarer.

Based on the above problems, the present invention develops a fully automated industrial-scale large-scale integrated device of CO₂ capture, sequestration and utilization and method for the continuous generation, separation and decomposition of hydrates, including a seawater desalination system and a carbon sequestration system, to solve the problem of utilizing and long-lasting sequestration after carbon capture.

### Content of the Invention

Based on the above problems, the present invention utilizes the hydrate generation and decomposition technology, designs four working schemes, and provides a large-scale CCUS full-process pilot equipment and method in order to achieve the two major goals of carbon capture and utilization.

The technical program of the present invention: A large-scale integrated device of CO₂ capture, sequestration and utilization, comprising a gas compression system, a liquid injection system, a hydrate generation and decomposition system, a refrigeration circulation system, a cold and energy storage system, a sequestration simulation system, an automatic control system, and a seawater desalination system;
the gas compression system comprises an air compressor 1, a gas mixture tank 2, electric valves 5, check valves 6, gas booster pumps 7, high-pressure buffer tanks 8, pressure sensors 9, gas flowmeters 10, a pipeline I, a pipeline II, a pipeline VI, a pipeline VII, a pipeline XII, and a pipeline VIII; the air compressor 1 is connected to the corresponding gas booster pumps 7 through the pipeline I, the pipeline II and the pipeline VIII, respectively, and pipes connecting the pipeline I, the pipeline II and the pipeline VIII to the corresponding gas booster pumps 7 are provided with the electric valves 5; the front and rear ends of each gas booster pump 7 are connected to a check valve 6, respectively, to ensure one-way gas flow; the rear end of each gas booster pump 7 is connected to a high-pressure buffer tank 8 through the check valve 6, the upper end of the high-pressure buffer tank 8 is equipped with a pressure sensor 9 to monitor the pressure in the high-pressure buffer tank 8 in real time; the high-pressure buffer tank 8 is connected to a gas flowmeter 10 to record the flow rate of the gases flowing through in real time;
the liquid injection system comprises a first water tank 3-1, a high-pressure injection pump 11, liquid flowmeters 12, electric valves 5, a pipeline III, a pipeline IV, a pipeline V, and a pipeline XVI; the first water tank 3-1 is connected to the liquid flowmeters 12 and the electric valves 5 on the pipeline IV and the pipeline V through the high-pressure injection pump 11 on the pipeline III, respectively, to provide water for a primary hydrate generation tank 16 and a secondary hydrate generation tank 21, and the flow rate of the water is recorded at the same time; water generated by hydrate decomposition in a primary hydrate decomposition tank 18 and a secondary hydrate decomposition tank 23 flows back to the first water tank 3-1 through the pipeline XVI for water recycling;
the hydrate generation and decomposition system comprises the primary hydrate generation tank 16, the electric valves 5, the primary hydrate decomposition tank 18, the secondary hydrate generation tank 21, the secondary hydrate decomposition tank 23, pressure sensors 9, temperature sensors 13, CO₂ concentration sensors 14, vacuum pumps 15, high-pressure buffer tanks 8, a pipeline IX, a pipeline X, a pipeline VII, a pipeline XI, a pipeline XIV, a pipeline XVIII, a pipeline XV and a pipeline XIX; the pressure sensors 9, the temperature sensors 13 and the CO₂ concentration sensors 14 are connected to both the primary hydrate generation tank 16 and the secondary hydrate generation tank 21 to monitor the temperature, the pressure and the CO₂ concentration in the hydrate generation tanks in real time, respectively; the pressure sensors 9 and the temperature sensors 13 are connected to both the primary hydrate decomposition tank 18 and the secondary hydrate decomposition tank 23 to monitor the temperature and the pressure in the hydrate decomposition tanks in real time, respectively;
the primary hydrate generation tank 16 and secondary hydrate generation tank 21 are correspondingly connected to the primary hydrate decomposition tank 18 and secondary hydrate decomposition tank 23 through the pipeline XIV and the pipeline XVIII, respectively, for transporting hydrates generated by reaction; the pipeline XIV and the pipeline XVIII are provided with the electric valves 5;
the primary hydrate generation tank 16 and secondary hydrate generation tank 21 are connected to the pipeline IX and a pipeline XXI correspondingly and respectively, the pipeline IX and the pipeline XXI are provided with the electric valves 5 and the vacuum pumps 15 in sequence, and residual gases in the hydrate generation tanks are pumped out by the vacuum pumps 15; the vacuum pump 15 at the upper tail end of the pipeline IX is taken as a division node, and two branches are formed after passing through the vacuum pump 15; one branch is connected to the pipeline XI, and the tail end of the pipeline XI is connected to the atmosphere for forward purification; the other branch is connected to the pipeline X, the pipeline X is provided with the electric valves 5 and the high-pressure buffer tank 8 for reverse purification; two branches are formed after passing through the high-pressure buffer tank 8 at the tail end of the pipeline X, one branch goes upward and is connected to the gas booster pump 7 on the pipeline VII through an electric valve 5, and the other branch goes downward and is connected to the gas booster pump 7 on the pipeline XII through an electric valve 5; the pipeline XXI starts from the secondary hydrate generation tank 21, and the pipeline is provided with an electric valve 5, a vacuum pump 15, a high-pressure buffer tank 8 with a pressure sensor 9, an electric valve 5, a check valve 6, a gas booster pump 7, a check valve 6, a high-pressure buffer tank 8 with a pressure sensor 9, a gas flowmeter 10, and an electric valve 5 in sequence; the rear end of the vacuum pump 15 on the pipeline XXI is connected to a pipeline XXX to be used as a final outlet of the residual gases in the secondary hydrate generation tank 21;
the primary hydrate generation tank 16 is connected to the secondary hydrate generation tank 21 through the pipeline IX, the pipeline X, and the pipeline XII (which is in the gas compression system) in sequence to transport the residual gases in the primary hydrate generation tank 16 to the secondary hydrate generation tank 21 for further reaction, and thus to complete the gas injection of the secondary hydrate generation tank 21;
the bottom of the primary hydrate decomposition tank 18 is connected to the pipeline XV and the pipeline A, respectively, through an electric valve 5, with the pipeline XV being used for discharging non-CO₂ gases and the pipeline A being used for discharging CO₂;
the bottom of the secondary hydrate decomposition tank 23 is connected to the pipeline XIX and the pipeline B, respectively, through an electric valve 5, with the pipeline XIX being used for discharging non-CO₂ gases and the pipeline B being used for discharging CO₂;
during hydrate generation, due to the continuous consumption of gases, it is necessary to carry out repressurization in four lines, which is respectively to:
repressurize the primary hydrate generation tank 16 by forward purification: the gas mixture tank 2 is connected to the primary hydrate generation tank 16 through the pipeline VI in the gas compression system to complete repressurization;
repressurize the secondary hydrate generation tank 21 by forward purification: the primary hydrate decomposition tank 18 is connected to the secondary hydrate generation tank 21 through the pipeline A, the vacuum pump 15 on the pipeline IX, the pipeline X, and the pipeline XII (which is in the gas compression system) in sequence to complete repressurization;
repressurize the primary hydrate generation tank 16 by reverse purification: the primary hydrate generation tank 16 is connected to the pipeline IX, the pipeline X, the pipeline VII (which is in the gas compression system), and then back to the primary hydrate generation tank 16 in sequence to complete repressurization; further, CO₂ with a certain pressure is pre-stored in the high pressure buffer tank 8 on the pipeline X;
repressurize the secondary hydrate generation tank 21 by reverse purification: the primary hydrate generation tank 16 is connected to the secondary hydrate generation tank 21 through the pipeline IX, the pipeline X, and the pipeline XII in (which is the gas compression system) in sequence to complete repressurization;
an outlet of pipeline A is connected to an inlet end of the vacuum pump 15 on the pipeline IX and is merged into the pipeline X after passing through the vacuum pump 15;
the hydrate refrigeration circulation system comprises a first refrigeration unit 17, a second refrigeration unit 22, a pipeline XIII and a pipeline XVII, and is used to provide a cooling capacity required for hydrate generation; the first refrigeration unit 17 and the second refrigeration unit 22 are connected to the primary hydrate generation tank 16 and the secondary hydrate generation tank 21 through the pipeline XIII and the pipeline XVII, respectively, and the pipeline XIII and the pipeline XVII are provided with electric valves 5;
the cold and energy storage system comprises a hot gas mixture tank 20, electric valves 5, a check valve 6, a gas booster pump 7, a gas flowmeter 10, a heat exchanger 19, a high-pressure injection pump 11, a second water tank 3-2, temperature sensors 13, a pipeline XXV, a pipeline XXVI, a pipeline XXVII, a pipeline XXVIII, a pipeline XXXI and a pipeline XXXII; high-temperature gases in the hot gas mixture tank 20 pass through an electric valve 5, the gas booster pump 7, the gas flowmeter 10 and an electric valve 5 in sequence and then enter the heat exchanger 19 to heat the water from the second water tank 3-2, and cold gases after being cooled down in the heat exchanger 19 are transported to the gas mixture tank 2 through the pipeline XXV; the high-pressure injection pump 11 is located on the pipeline XXVII, water from the second water tank 3-2 passes through the high-pressure injection pump 11 and enters the heat exchanger 19 to be heated and then transported to a water outlet of the heat exchanger 19, the water outlet of the heat exchanger 19 is divided into two branches, one branch is the pipeline XXXI which is provided with an electric valve 5 and a temperature sensor 13, the tail end of the pipeline XXXI is connected to the primary hydrate decomposition tank 18, and the water is returned to the second water tank 3-2 through the pipeline XXVII with a temperature sensor 13 after heat release is completed in a coil of the primary hydrate decomposition tank 18; the other branch is the pipeline XXVIII which is connected before the electric valve 5 on the pipeline XXXI, the pipeline XXVIII is also provided with an electric valve 5 and a temperature sensor 13, the tail end of the pipeline XXVIII is connected to the secondary hydrate decomposition tank 23, and the water is returned to the second water tank 3-2 through the pipeline XXXII with a temperature sensor 13 after heat release is completed in a coil of the secondary hydrate decomposition tank 23;
the sequestration simulation system comprises pressure sensors 9, a temperature sensor 13, a CO₂ sequestration tank 27, an oil tank 24, an axial pressure tracking pump 25, a peripheral pressure tracking pump 26, a CO₂ sequestration tank 27, the pipeline XXI, a pipeline XXII and a pipeline XXIII;
high-concentration CO₂ enters the CO₂ sequestration tank 27 through the pipeline XXI, and the high-concentration CO₂ is from two sources:
source 1: the high-concentration CO₂ is discharged from the secondary hydrate decomposition tank 23 and merged into the pipeline XXI through the pipeline B, and the tail end of the pipeline B is connected to an inlet of the vacuum pump 15 on the pipeline XXI;
source 2: the high-concentration CO₂ is discharged from the secondary hydrate generation tank 21 and enters the pipeline XXI directly;
the CO₂ sequestration tank 27 is provided with a pressure sensor 9 and the temperature sensor 13 to monitor the temperature and the pressure in the CO₂ sequestration tank 27 in real time;
the pipeline XXII is provided with an electric valve 5, an oil tank 24-1, an electric valve 5, the axial pressure tracking pump 25 with a pressure sensor 9, and an electric valve 5 in sequence, and is then connected to the CO₂ sequestration tank 27;
the pipeline XXIII is provided with an electric valve 5, an oil tank 24-2, an electric valve 5, the peripheral pressure tracking pump 26 with a pressure sensor 9, and an electric valve 5 in sequence, and is then connected to the CO₂ sequestration tank 27;
the automatic control system comprises a computer 28, a display, a touch screen and an interface;
the seawater desalination system comprises a seawater tank 4, a pipeline XXIX, a high-pressure injection pump 11, electric valves 5, a pipeline XXIV, a pipeline XX and a pipeline C; seawater is injected into the secondary hydrate generation tank 21 under pressure through the high-pressure injection pump 11 and the electric valve 5 on pipeline XXIX, generated hydrates and high-concentration brine enter the secondary hydrate decomposition tank 23 through the pipeline XVIII together, and prior to hydrate decomposition in the secondary hydrate decomposition tank 23, the high-concentration brine is recovered through the pipeline XXIV; the lower part of the secondary hydrate decomposition tank 23 is connected to the pipeline C, and after the pipeline C is connected to the gas flowmeter 10 on the pipeline XXI, the secondary hydrate decomposition tank 23 is repressurized by the high-concentration CO₂ in the high-pressure buffer tank 8 on the pipeline XXI to make the high-concentration brine flow out smoothly, and fresh water generated after hydrate decomposition flows back to the first tank 3-1 through the pipeline XX and the pipeline XVI.

The liquid injection system in the large-scale integrated device of CO₂ capture, sequestration and utilization is divided into three lines:
the first water tank (3-1) is connected to the liquid flowmeter (12) and the electric valve (5) on the pipeline V through the high-pressure injection pump (11) on the pipeline III to provide water for a primary hydrate generation tank (16), and this line is a water injection line for the primary hydrate generation tank (16);
the first water tank (3-1) is connected to the liquid flowmeter (12) and the electric valve (5) on the pipeline IV through the high-pressure injection pump (11) on the pipeline III to provide water for a secondary hydrate generation tank (21), and this line is a water injection line for the secondary hydrate generation tank (21);
the seawater in the seawater tank (4) is injected into the secondary hydrate generation tank (21) under pressure through the high-pressure injection pump (11) and the electric valve (5) on the pipeline XXIX, and the liquid flowmeter (12) and the electric valve (5) on the pipeline IV, and this line is a seawater injection line for the secondary hydrate generation tank (21).

The liquid injection system is divided into three lines: The first water tank 3-1 is connected to the liquid flow meter 12 and electric valve 5 on pipeline V through the high-pressure injection pump 11 on pipeline III, and is a first-level hydrate generation tank 16 Provide water, this line is the water injection line of the primary hydrate generation tank 16;

The first water tank 3-1 is connected to the liquid flow meter 12 and electric valve 5 on pipeline IV through the high-pressure injection pump 11 on pipeline III, and is a secondary hydrate generation tank 21 Provide water, this line is the water injection line of the secondary hydrate generation tank 21;

The seawater in the seawater tank 4 passes through the high-pressure injection pump 11 and electric valve 5 on pipeline XXIX, the liquid flow meter 12 and electric valve 5 on pipeline IV, and is injected into the secondary level under pressure. In the hydrate generation tank 21, this line is the seawater injection line of the secondary hydrate generation tank 21.

### Beneficial Effects of the Present Invention

Based on the CO₂ hydrate generation and decomposition technology, the present invention proposes a large-scale integrated device of CO₂ capture, sequestration and utilization and method;
1. The device of the present invention can realize the full process, high efficiency, low energy consumption and automated collection of CO₂ from exhaust gases of industrial sources;
2. The device of the present invention is applicable to different ways of CO₂ separation and purification mode, can be from the forward or reverse way of CO₂ separation and purification, in order to meet the different experimental simulation needs of the function;
3. The invention device can realize real-time monitoring reaction tank hydrate generation process state changes, for experimental personnel on the hydrate in different test conditions, generation rate, generation amount of research to provide research support function;
4. The invention device configuration of cold storage system can realize the industrial high temperature exhaust gas energy secondary utilization function;
5. The invention device configuration sealing simulation system, the purification of CO₂ sealing, the system configuration axial pressure and pressure system, can simulate the pressure environment of the deep sea ocean, for CO₂ deep sea sealing to provide experimental support function;
6. The device of the present invention is equipped with a seawater desalination system, which can carry out seawater desalination through the hydrate method.

The device achieves the two main working objectives of carbon capture and utilization, and is also important for subsequent research on hydrate applications.

### ILLUSTRATE WITH DIAGRAMS

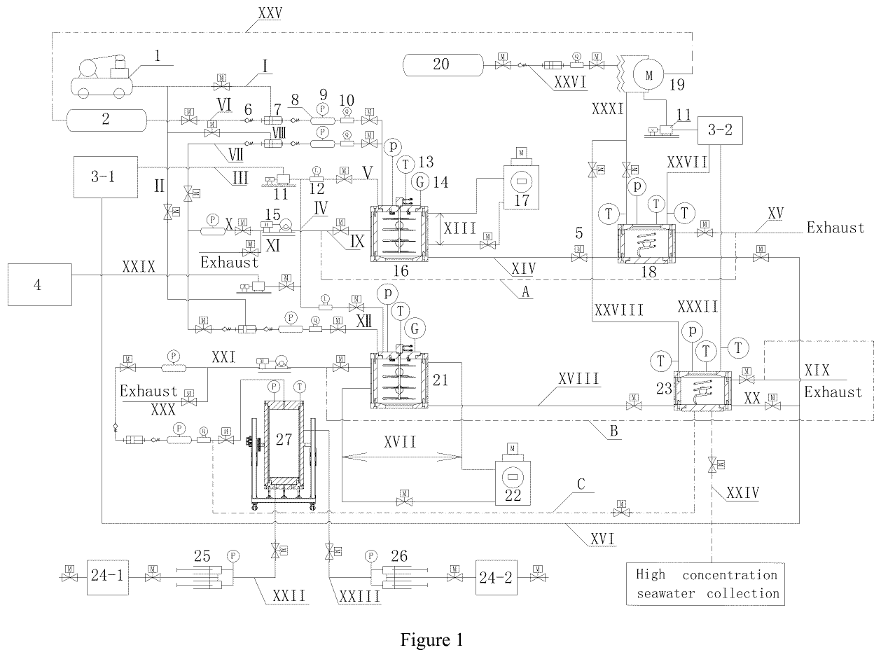

FIG. 1 shows a general diagram of a large-scale integrated device of CO₂ capture, sequestration and utilization and method;

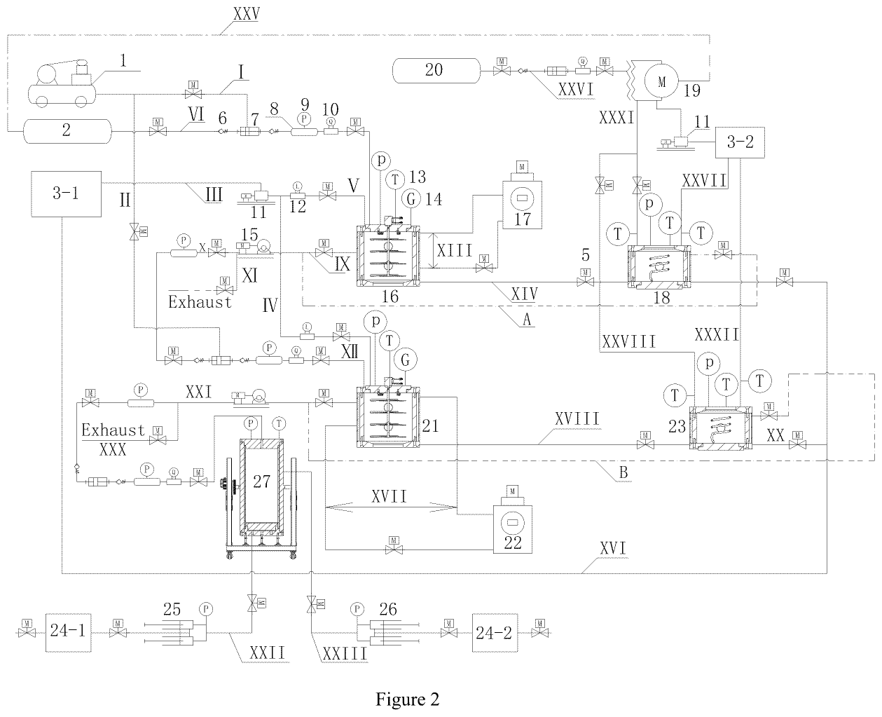

FIG. 2 shows a flow chart of hydrate forward purification of CO₂ in FIG. 1;

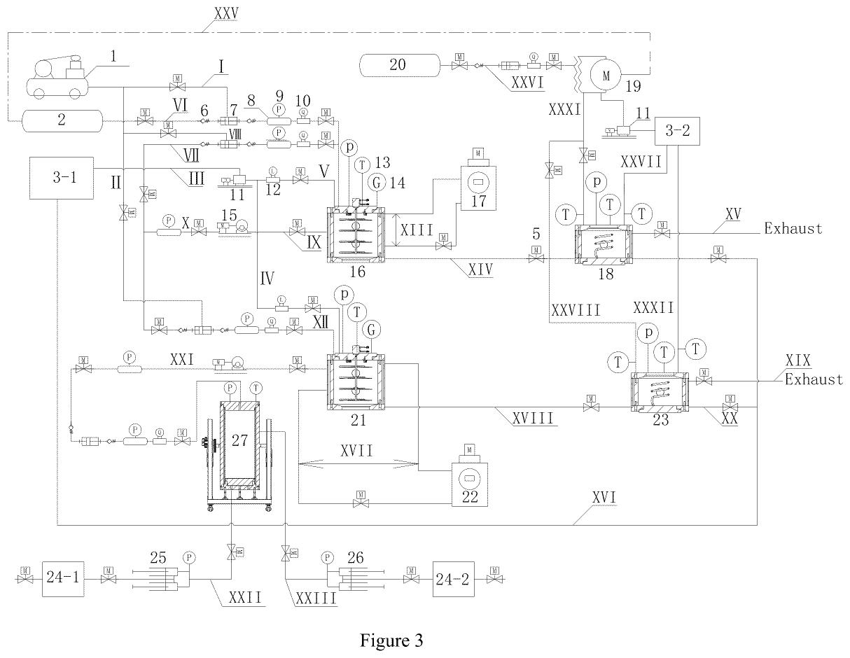

FIG. 3 shows the hydrate reverse purification CO₂ flow diagram in FIG. 1;

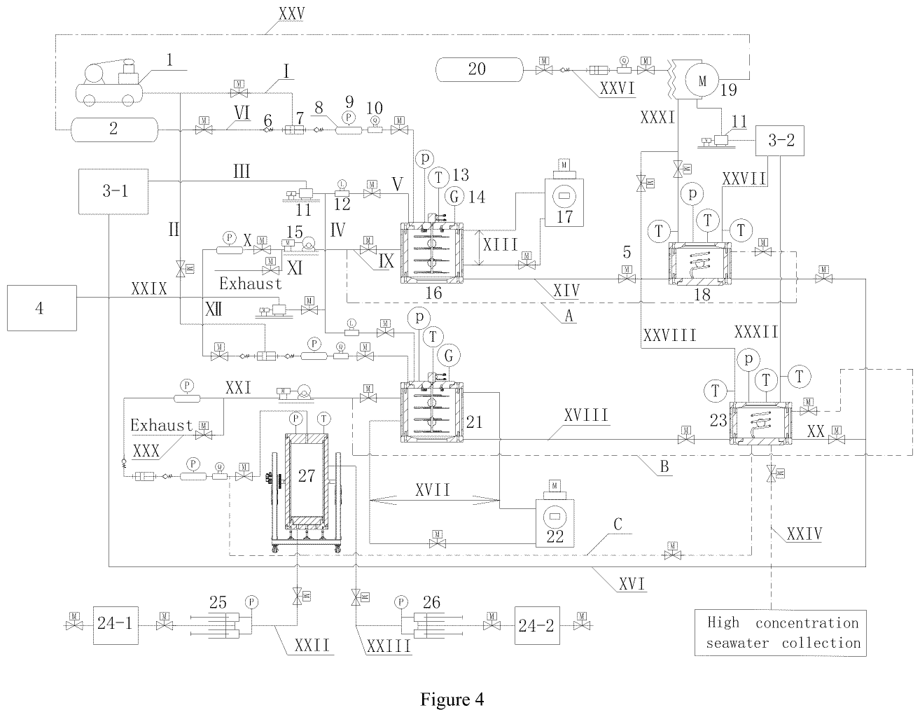

FIG. 4 shows the flow chart of hydrate forward purification of CO₂ and desalination of seawater in FIG. 1;

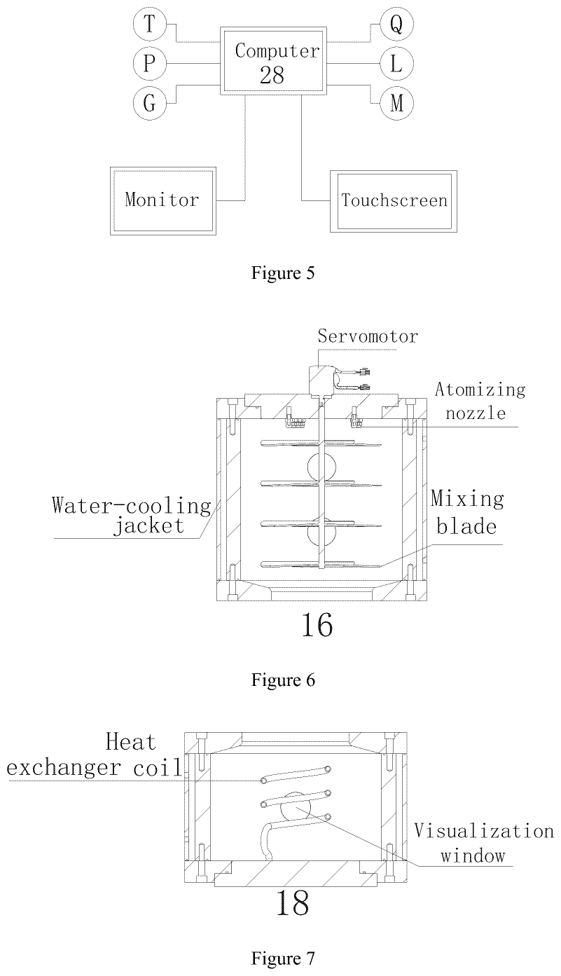

FIG. 5 shows a diagram of the automatic control system in FIG. 1;

FIG. 6 shows a schematic diagram of the hydrate generation tank in FIG. 1;

FIG. 7 shows a schematic diagram of the hydrate decomposition tank in FIG. 1;

In the figure: 1 air compressor; 2 gas mixture tank; 3 water tank; 4 seawater tank; 5 electric valve; 6 check valve; 7 gas booster pump; 8 high-pressure buffer tank; 9 pressure sensor; 9 gas flowmeter; 11 high-pressure injection pump; 12 liquid flowmeter; 13 temperature sensor; 14 CO₂ concentration sensor; 15 vacuum pump; 16 primary hydrate generation tank; 17 first refrigeration unit; 18 primary hydrate decomposition tank; 19 heat exchanger; 20 hot mix gas tank; 21 secondary hydrate generation tank; 22 second refrigeration unit; 23 secondary hydrate decomposition tank; 24 oil tank; 25 axial pressure tracking pump; 26 peripheral pressure tracking pump; 27 CO₂ sequestration tank; 28 computer.

### SPECIFIC EMBODIMENTS

Specific embodiments of the present invention are further described below in connection with the technical scheme and the accompanying drawings.

This large-scale integrated device of CO₂ capture, sequestration and utilization and method can realize four working scenarios, including two-stage hydrate forward purification of CO₂, hydrate reverse purification of CO₂, hydrate forward purification of CO₂ and desalination of seawater, and CO₂ sequestration process.

### Implementation Example 1

The method of large-scale integrated device of CO₂ capture, sequestration and utilization for two-stage hydrate forward purification of CO₂, the steps are as follows:
step 1: generation of CO₂ hydrate by primary hydrate generation tank 16;
starting the air compressor 1, opening the electric valve 5 on the pipeline I and the first electric valve 5 on the pipeline VI through which gas mixture outflow passes, and pumping the gas mixture in the gas mixture tank 2 into the high-pressure buffer tank 8 through the gas booster pump 7; when the pressure detected by the pressure sensor 9 on the high-pressure buffer tank 8 is stable, opening the second electric valve 5 on the pipeline VI through which gas mixture outflow passes, and pumping the gas mixture in the high-pressure buffer tank 8 into the primary hydrate generation tank 16; when a target injection volume is detected by the gas flowmeter 10 on the pipeline VI or a target pressure is detected by the pressure sensor 9 on the primary hydrate generation tank 16, closing the electric valves 5 on the pipeline, and shutting down the air compressor 1 to stop gas injection;
at the same time, opening the electric valve 5 on the pipeline V, injecting the water in the first water tank 3-1 into the primary hydrate generation tank 16 by the high-pressure injection pump 11 through the pipeline III and the pipeline V; when a target injection volume is detected by a liquid flowmeter 12 on the pipeline V, closing the electric valve 5 on the pipeline V to stop water injection;
at the same time, opening the electric valve 5 on the pipeline XIII, and making the first refrigeration unit 17 work continuously to provide cooling water for a water cooling jacket of the primary hydrate generation tank 16, so as to ensure that the temperature of the primary hydrate generation tank 16 is constant at the hydrate reaction temperature;
when hydrate generation begins, making the water react with the CO₂ in the gas mixture to generate CO₂ hydrate, thus to separate the CO₂ in the gas mixture; however, in this process, a small amount of hydrates will also be generated by some impurity gases;
when hydrate generation is finished, opening the electric valves 5 on the pipeline IX and the pipeline XI, and discharging the residual exhaust gas in the generation tank through the pipeline IX and the pipeline XI;
step 2: hydrate transport;
after the concentration of primarily purified CO₂ drops to a set value, sending a signal to the computer 28 by the CO₂ concentration sensor 14, activating the function of controlling hydrate transport, opening the electric valve 5 on the pipeline XIV, and transporting the hydrate in the primary hydrate generation tank 16 to the primary hydrate decomposition tank 18;
when a pressure decrease is detected by the pressure sensor 9 in the primary hydrate generation tank 16, opening the electric valve 5 on the pipeline I and the first electric valve 5 on the pipeline VI through which gas mixture outflow passes, and repressurizing the primary hydrate generation tank 16 by forward purification to maintain the reaction pressure in the primary hydrate generation tank 16;
since the volume of the hydrate generation tank is greater than that of the hydrate decomposition tank, hydrate transport will be promoted by the inlet repressurization process, and at the same time, residual hydrate slurry in the hydrate generation tank will play a function of inducing subsequent hydrate generation;
when the reading of the pressure sensor 9 on the primary hydrate decomposition tank 18 is the same as that of the pressure sensor 9 on the primary hydrate generation tank 16, closing the electric valves 5 on all the above mentioned pipelines to finish hydrate transport;
step 3: decomposition of CO₂ hydrate by primary hydrate decomposition tank 18;
after the hydrate enters the primary hydrate decomposition tank 18, starting the heat exchanger 19 and the high-pressure injection pump 11 (which is in the cold and energy storage system), and opening the first electric valve 5 on the pipeline XXVI through which high-temperature exhaust gas outflow passes; when a target injection volume is detected by the gas flowmeter 10 on the pipeline XXVI, closing the first electric valve 5 on the pipeline XXVI through which high-temperature exhaust gas outflow passes, opening the second electric valve 5 on the pipeline XXVI through which high-temperature exhaust gas outflow passes, and making high-temperature industrial exhaust gas flow out of the hot gas mixture tank 20 and enter the heat exchanger 19 through the pipeline XXVI; after heat exchange, making low-temperature industrial exhaust gas enter the gas mixture tank 2 through the pipeline XXV;
starting the high-pressure injection pump 11, pumping low-temperature circulating water in the second water tank 3-2 into the heat exchanger 19, opening the electric valve 5 on the pipeline XXXI, and after heat exchange, making high-temperature circulating water enter a heat exchange coil in the primary hydrate decomposition tank 18 through the pipeline XXXI to provide heat energy for hydrate decomposition and accelerate hydrate decomposition reaction; after heat release is completed, making the low-temperature water return to the second water tank 3-2 through the pipeline XXVII;
generating water and CO₂ after the decomposition of the CO₂ hydrate in the primary hydrate decomposition tank 18; when a target parameter is detected by the pressure sensor 9 or the temperature sensor 13 on the primary hydrate decomposition tank 18, opening the electric valve 5 on the pipeline XVI, making the water flow back to the first tank 3-1 through the pipeline XVI, opening the electric valve 5 on the pipeline X, and making the gas flow through the pipeline A and the pipeline X and be collected by the vacuum pump 15 into the high-pressure buffer tank 8; after decomposition products flow out, closing the electric valves 5 on all the pipelines in the above steps;
step 4: generation of CO₂ hydrate by secondary hydrate generation tank 21;
opening the first electric valve 5 through which the pipeline XII passes, i.e. the valve located in front of an inlet of the gas booster pump 7; when a target injection volume is detected by the gas flowmeter 10 on the pipeline XII, opening the second electric valve 5 through which the pipeline XII passes, i.e. the valve located behind an outlet of high-pressure buffer tank 8, and injecting the gas primarily purified and collected in the high-pressure buffer tank 8 on the pipeline XII into the secondary hydrate generation tank 21; when a target injection volume is detected by the gas flowmeter 10 on the pipeline XII or a target pressure is detected by the pressure sensor 9 on the secondary hydrate generation tank 21, closing the electric valves 5 on the pipeline XII to stop gas injection; at the same time, starting the high-pressure injection pump 11, opening the electric valve 5 on the pipeline IV, injecting the water in the first water tank 3-1 into the primary hydrate generation tank 16 by the high-pressure injection pump 11 through the pipeline III and the pipeline IV; when a target injection volume is detected by a liquid flowmeter 12 on the pipeline IV, closing the electric valve 5 on the pipeline IV to stop water injection; at the same time, opening the electric valve 5 on the pipeline XVII, and making the second refrigeration unit 22 work continuously;
repeating the primary CO₂ hydrate generation process to conduct secondary purification;
when hydrate generation is finished, starting the vacuum pump 15, opening the electric valve 5 on the pipeline XXX, and discharging the residual exhaust gas in the secondary hydrate generation tank 21 through the electric valve 5 and the vacuum pump 15 on the pipeline XXI, and the pipeline XXX;
step 5: hydrate transport;
   after the concentration of secondarily purified CO₂ drops to a set value, sending a signal to the computer 28 by the CO₂ concentration sensor 14; activating the function of controlling hydrate transport, opening the electric valve 5 on the pipeline XVIII, and transporting the hydrate in the secondary hydrate generation tank 21 to the secondary hydrate decomposition tank 23;
when a pressure decrease is detected by the pressure sensor 9 in the secondary hydrate generation tank 21, opening the electric valves 5 on the pipeline II, the pipeline A, the pipeline X and the pipeline XII, starting the air compressor 1 and the vacuum pump 15 (which is on the pipeline IX), repressurizing the secondary hydrate generation tank 21 by forward purification, and injecting the primarily purified gas into the secondary hydrate generation tank 21;
when the reading of the pressure sensor 9 on the secondary hydrate decomposition tank 23 is the same as that of the pressure sensor 9 on the secondary hydrate generation tank 21, closing the electric valves 5 on all the above mentioned pipelines to finish hydrate transport;
step 6: decomposition of CO₂ hydrate by secondary hydrate decomposition tank 23;
after the hydrate enters the secondary hydrate decomposition tank 23, starting the heat exchanger 19 and the high-pressure injection pump 11 (which is in the cold and energy storage system), and opening the first electric valve 5 on the pipeline XXVI through which the high-temperature exhaust gas passes; when a target injection volume is detected by the gas flowmeter 10 on the pipeline XXVI, closing the first electric valve 5 on the pipeline XXVI through which the high-temperature exhaust gas passes, opening the second electric valve 5 on the pipeline XXVI through which the high-temperature exhaust gas passes, and making high-temperature industrial exhaust gas flow out of the hot gas mixture tank 20 and enter the heat exchanger 19 through the pipeline XXVI; after heat exchange, making low-temperature industrial exhaust gas enter the gas mixture tank 2 through the pipeline XXV;
starting the high-pressure injection pump 11, pumping low-temperature circulating water in the second water tank 3-2 into the heat exchanger 19, opening the electric valve 5 on the pipeline XXVIII, and after heat exchange, making high-temperature circulating water enter a heat exchange coil in the secondary hydrate decomposition tank 23 through the pipeline XXVIII to provide heat energy for hydrate decomposition and accelerate hydrate decomposition reaction; after heat release is completed, making the low-temperature water return to the second water tank 3-2 through the pipeline XXXII;
repeating the primary CO₂ hydrate decomposition process to conduct secondary purification;
generating water and CO₂ after the decomposition of the CO₂ hydrate in the secondary hydrate decomposition tank 23, opening the electric valve 5 on the pipeline XX, and making the water flow back to the first tank 3-1 through the pipeline XX and the pipeline XVI; opening the electric valve 5 on the pipeline B, starting the vacuum pump 15 on the pipeline XXI, decomposing the purified gas in the secondary hydrate decomposition tank 23, and making the gas flow through the pipeline B to be collected by the vacuum pump 15 into the high-pressure buffer tank 8; after decomposition products flow out, closing the electric valves 5 on all the above mentioned pipelines.

### Implementation Example 2

The large-scale integrated device of CO₂ capture, sequestration and utilization is also used in a method for realizing reverse purification of CO₂ from hydrates, comprising the following steps:
step 1: generation of non-CO₂ hydrates by primary hydrate generation tank 16;
starting the air compressor 1, opening the electric valve 5 on the pipeline I and the first electric valve 5 on the pipeline VI through which the gas mixture passes, and pumping the gas mixture in the gas mixture tank 2 into the high-pressure buffer tank 8 through the gas booster pump 7; when the pressure detected by the pressure sensor 9 on the high-pressure buffer tank 8 is stable, opening the second electric valve 5 on the pipeline VI through which the gas mixture passes, and pumping the gas mixture in the high-pressure buffer tank 8 into the primary hydrate generation tank 16; when a target injection volume is detected by the gas flowmeter 10 on the pipeline VI or a target pressure is detected by the pressure sensor 9 on the primary hydrate generation tank 16, closing the electric valves 5 on the pipeline, and shutting down the air compressor 1 to stop gas injection;
at the same time, opening the electric valve 5 on the pipeline V, injecting the water in the first water tank 3-1 into the primary hydrate generation tank 16 by the high-pressure injection pump 11 through the pipeline III and the pipeline V; when a target injection volume is detected by a liquid flowmeter 12 on the pipeline V, closing the electric valve 5 on the pipeline V to stop water injection;
at the same time, opening the electric valve 5 on the pipeline XIII, and making the first refrigeration unit 17 work continuously to provide cooling water for a water cooling jacket of the primary hydrate generation tank 16, so as to ensure that the temperature of the primary hydrate generation tank 16 is constant at the hydrate reaction temperature;
when hydrate generation begins, making pure water react with non-CO₂ gases in the gas mixture to generate hydrates, and high-concentration CO₂ and some impurity gases will be left in the tank; when hydrate generation is finished, opening the electric valve 5 on the pipeline IX, pumping the high-concentration CO₂ and some impurity gases through the pipeline IX into the high-pressure buffer tank 8 to make preparation for secondary purification;
step 2: hydrate transport;
after the concentration of primarily purified CO₂ drops to a set value, sending a signal to the computer 28 by the CO₂ concentration sensor 14, activating the function of controlling hydrate transport, opening the electric valve 5 on the pipeline XIV, and transporting the hydrate in the primary hydrate generation tank 16 to the primary hydrate decomposition tank 18;
when a pressure decrease is detected by the pressure sensor 9 in the hydrates in the primary hydrate generation tank 16, carrying out inlet repressurization to the primary hydrate generation tank 16 by reverse purification, with the specific process as follows:
during initial operation, opening the electric valve 5 on the pipeline VIII and the second electric valve 5 through which the pipeline VII passes, i.e. the valve located behind an outlet of high-pressure buffer tank 8, pre-storing CO₂ with a certain pressure in the high-pressure buffer tank 8, and pumping high-concentration CO₂ and some impurity gases into the primary hydrate generation tank 16 through the gas booster pump 7 to maintain the reaction pressure in the primary hydrate generation tank 16;
during subsequent operation, opening the electric valves 5 on the pipeline VIII, the pipeline IX and the pipeline X, opening the first electric valve 5 through which the pipeline VII passes, i.e. the valve located in front of an inlet of the gas booster pump 7, and pumping the high-concentration CO₂ and some impurity gases into the high-pressure buffer tank 8; when the pressure detected by the pressure sensor 9 is stable, opening the second electric valve 5 through which the pipeline VII passes, i.e. the valve located behind an outlet of high-pressure buffer tank 8, pumping the high-concentration CO₂ and some impurity gases into the primary hydrate generation tank 16 through the gas booster pump 7 to maintain the reaction pressure in the primary hydrate generation tank 16;
since the volume of the hydrate generation tank is greater than that of the hydrate decomposition tank, hydrate transport will be promoted by the inlet repressurization process, and at the same time, residual hydrate slurry in the hydrate generation tank will play a function of inducing subsequent hydrate generation;
when the reading of the pressure sensor 9 on the primary hydrate decomposition tank 18 is the same as that of the pressure sensor 9 on the primary hydrate generation tank 16, closing the electric valves 5 on all the above mentioned pipelines to finish hydrate transport;
step 3: decomposition of non-CO₂ hydrates by primary hydrate decomposition tank 18;
after the hydrate enters the primary hydrate decomposition tank 18, starting the heat exchanger 19 and the high-pressure injection pump 11 (which is in the cold and energy storage system), and opening the first electric valve 5 on the pipeline XXVI through which the high-temperature exhaust gas passes; when a target injection volume is detected by the gas flowmeter 10 on the pipeline XXVI, closing the first electric valve 5 on the pipeline XXVI through which the high-temperature exhaust gas passes, opening the second electric valve 5 through which the high-temperature exhaust gas passes, and making high-temperature industrial exhaust gas flow out of the hot gas mixture tank 20 and enter the heat exchanger 19 through the pipeline XXVI; after heat exchange, making low-temperature industrial exhaust gas enter the gas mixture tank 2 through the pipeline XXV;
starting the high-pressure injection pump 11, pumping low-temperature circulating water in the second water tank 3-2 into the heat exchanger 19, opening the electric valve 5 on the pipeline XXXI, and after heat exchange, making high-temperature circulating water enter a heat exchange coil in the primary hydrate decomposition tank 18 through the pipeline XXXI to provide heat energy for hydrate decomposition and accelerate hydrate decomposition reaction; after heat release is completed, making the low-temperature water return to the second water tank 3-2 through the pipeline XXVII;
generating water and CO₂ after the decomposition of the non-CO₂ hydrates in the primary hydrate decomposition tank 18; when a target parameter is detected by the pressure sensor 9 or the temperature sensor 13 on the primary hydrate decomposition tank 18, discharging gases by the following steps: opening the electric valve 5 on the pipeline XV, and discharging the gases generated by decomposition in the primary hydrate decomposition tank 18 into the atmosphere through the pipeline XV;
after decomposition products flow out, closing the electric valves 5 on all the pipelines in the above steps;
step 4: generation of non-CO₂ hydrates by secondary hydrate generation tank 21;
opening the first electric valve 5 through which the pipeline XII passes, i.e. the valve located in front of an inlet of the gas booster pump 7; when a target injection volume is detected by the gas flowmeter 10 on the pipeline XII, opening the second electric valve 5 through which the pipeline XII passes, i.e. the valve located behind an outlet of high-pressure buffer tank 8, and injecting the gas primarily purified and collected in the high-pressure buffer tank 8 on the pipeline XII into the secondary hydrate generation tank 21; when hydrate generation begins, making pure water react with non-CO₂ gases in the gas mixture to generate hydrates, and high-concentration CO₂ will be left in the secondary hydrate generation tank 21; when a target injection volume is detected by the gas flowmeter 10 on the pipeline XII or a target pressure is detected by the pressure sensor 9 on the secondary hydrate generation tank 21, closing the electric valves 5 on the pipeline XII to stop gas injection;
at the same time, starting the high-pressure injection pump 11, opening the electric valve 5 on the pipeline IV, injecting the water in the first water tank 3-1 into the primary hydrate generation tank 16 by the high-pressure injection pump 11 through the pipeline III and the pipeline IV; when a target injection volume is detected by a liquid flowmeter 12 on the pipeline IV, closing the electric valve 5 on the pipeline IV to stop water injection;
at the same time, opening the electric valve 5 on the pipeline XVII, and making the second refrigeration unit 22 work continuously;
repeating the primary non-CO₂ hydrate generation process to conduct secondary purification;
collecting secondarily purified CO₂ into the high-pressure buffer tank 8 by the vacuum pump 15 on the pipeline XXI;
step 5: hydrate transport;
after the concentration of secondarily purified CO₂ drops to a set value, sending a signal to the computer 28 by the CO₂ concentration sensor 14; activating the function of controlling hydrate transport, opening the electric valve 5 on the pipeline XVIII, and transporting the hydrate in the secondary hydrate generation tank 21 to the secondary hydrate decomposition tank 23;
when a pressure decrease is detected by the pressure sensor 9 in the secondary hydrate generation tank 21, repressurizing the secondary hydrate generation tank 21 by reverse purification, with the specific process as follows: opening the electric valves 5 on the pipeline II and the pipeline XII, starting the air compressor 1, and injecting the gases purified and collected in the high-pressure buffer tank 8 on the pipeline X into the secondary hydrate generation tank 21 through the pipeline XII;
when the reading of the pressure sensor 9 on the secondary hydrate decomposition tank 23 is the same as that of the pressure sensor 9 on the secondary hydrate generation tank 21, closing the electric valves 5 on all the above mentioned pipelines to finish hydrate transport;
step 6: decomposition of non-CO₂ hydrates by secondary hydrate decomposition tank 23;
after the hydrate enters the secondary hydrate decomposition tank 23, starting the heat exchanger 19 and the high-pressure injection pump 11 (which is in the cold and energy storage system), and opening the first electric valve 5 on the pipeline XXVI through which the high-temperature exhaust gas passes; when a target injection volume is detected by the gas flowmeter 10 on the pipeline XXVI, closing the first electric valve 5 on the pipeline XXVI through which the high-temperature exhaust gas passes, opening the second electric valve 5 on the pipeline XXVI through which the high-temperature exhaust gas passes, and making high-temperature industrial exhaust gas flow out of the hot gas mixture tank 20 and enter the heat exchanger 19 through the pipeline XXVI; after heat exchange, making low-temperature industrial exhaust gas enter the gas mixture tank 2 through the pipeline XXV;
starting the high-pressure injection pump 11, pumping low-temperature circulating water in the second water tank 3-2 into the heat exchanger 19, opening the electric valve 5 on the pipeline XXVIII, and after heat exchange, making high-temperature circulating water enter a heat exchange coil in the secondary hydrate decomposition tank 23 through the pipeline XXVIII to provide heat energy for hydrate decomposition and accelerate hydrate decomposition reaction; after heat release is completed, making the low-temperature water return to the second water tank 3-2 through the pipeline XXXII;
repeating the primary non-CO₂ hydrate decomposition process to conduct secondary purification;
generating water and CO₂ after the decomposition of the CO₂ hydrate in the secondary hydrate decomposition tank 23, opening the electric valve 5 on the pipeline XX, and making the water flow back to the first tank 3-1 through the pipeline XX; opening the electric valve 5 on the pipeline B, and starting the vacuum pump 15 on the pipeline XXI;
generating water and non-CO₂ gases after the decomposition of the non-CO₂ hydrates in the secondary hydrate decomposition tank 23, and discharging the gases into the atmosphere through the pipeline XIX;
   after decomposition products flow out, closing the electric valves 5 on all the above mentioned pipelines.

### Implementation Example 3

The method for realizing forward purification of CO₂ from hydrates and desalinating seawater by the large-scale integrated device of CO₂ capture, sequestration and utilization, comprising the following steps:
step 1: primary purification of CO₂;
1) generation of CO₂ hydrate by primary hydrate generation tank 16;
starting the air compressor 1, opening the electric valve 5 on the pipeline I and the first electric valve 5 on the pipeline VI through which the gas mixture passes, and pumping the gas mixture in the gas mixture tank 2 into the high-pressure buffer tank 8 through the gas booster pump 7; when the pressure detected by the pressure sensor 9 on the high-pressure buffer tank 8 is stable, opening the second electric valve 5 on the pipeline VI through which the gas mixture passes, and pumping the gas mixture in the high-pressure buffer tank 8 into the primary hydrate generation tank 16; when a target injection volume is detected by the gas flowmeter 10 on the pipeline VI or a target pressure is detected by the pressure sensor 9 on the primary hydrate generation tank 16, closing the electric valves 5 on the pipeline, and shutting down the air compressor 1 to stop gas injection;
at the same time, opening the electric valve 5 on the pipeline V, injecting the water in the first water tank 3-1 into the primary hydrate generation tank 16 by the high-pressure injection pump 11 through the pipeline III and the pipeline V; when a target injection volume is detected by a liquid flowmeter 12 on the pipeline V, closing the electric valve 5 on the pipeline V to stop water injection;
at the same time, opening the electric valve 5 on the pipeline XIII, and making the first refrigeration unit 17 work continuously to provide cooling water for a water cooling jacket of the primary hydrate generation tank 16, so as to ensure that the temperature of the primary hydrate generation tank 16 is constant at the hydrate reaction temperature;
when hydrate generation begins, making the water react with the CO₂ in the gas mixture to generate CO₂ hydrate, thus to separate the CO₂ in the gas mixture; however, in this process, a small amount of hydrates will also be generated by some impurity gases;
when hydrate generation is finished, opening the electric valves 5 on the pipeline IX and the pipeline XI, and discharging the residual exhaust gas in the generation tank through the pipeline IX and the pipeline XI;
2) hydrate transport;
after the concentration of primarily purified CO₂ drops to a set value, sending a signal to the computer 28 by the CO₂ concentration sensor 14, activating the function of controlling hydrate transport, opening the electric valve 5 on the pipeline XIV, and transporting the hydrate in the primary hydrate generation tank 16 to the primary hydrate decomposition tank 18;
when a pressure decrease is detected by the pressure sensor 9 in the primary hydrate generation tank 16, opening the electric valve 5 on the pipeline I and the first electric valve 5 on the pipeline VI through which the gas mixture passes, and repressurizing the primary hydrate generation tank 16 by forward purification to maintain the reaction pressure in the primary hydrate generation tank 16;
since the volume of the hydrate generation tank is greater than that of the hydrate decomposition tank, hydrate transport will be promoted by the inlet repressurization process, and at the same time, residual hydrate slurry in the hydrate generation tank will play a function of inducing subsequent hydrate generation;
when the reading of the pressure sensor 9 on the primary hydrate decomposition tank 18 is the same as that of the pressure sensor 9 on the primary hydrate generation tank 16, closing the electric valves 5 on all the above mentioned pipelines to finish hydrate transport;
3) decomposition of CO₂ hydrate by primary hydrate decomposition tank 18;
after the hydrate enters the primary hydrate decomposition tank 18, starting the heat exchanger 19 and the high-pressure injection pump 11 in the cold and energy storage system, and opening the first electric valve 5 on the pipeline XXVI through which the high-temperature exhaust gas passes; when a target injection volume is detected by the gas flowmeter 10 on the pipeline XXVI, closing the first electric valve 5 on the pipeline XXVI through which the high-temperature exhaust gas passes, opening the second electric valve 5 on the pipeline XXVI through which the high-temperature exhaust gas passes, and making high-temperature industrial exhaust gas flow out of the hot gas mixture tank 20 and enter the heat exchanger 19 through the pipeline XXVI; after heat exchange, making low-temperature industrial exhaust gas enter the gas mixture tank 2 through the pipeline XXV;
starting the high-pressure injection pump 11, pumping low-temperature circulating water in the second water tank 3-2 into the heat exchanger 19, opening the electric valve 5 on the pipeline XXXI, and after heat exchange, making high-temperature circulating water enter a heat exchange coil in the primary hydrate decomposition tank 18 through the pipeline XXXI to provide heat energy for hydrate decomposition and accelerate hydrate decomposition reaction; after heat release is completed, making the low-temperature water return to the second water tank 3-2 through the pipeline XXVII;
generating water and CO₂ after the decomposition of the CO₂ hydrate in the primary hydrate decomposition tank 18; when a target parameter is detected by the pressure sensor 9 or the temperature sensor 13 on the primary hydrate decomposition tank 18, opening the electric valve 5 on the pipeline XVI, making the water flow back to the first tank 3-1 through the pipeline XVI, opening the electric valve 5 on the pipeline X, and making the gas flow through the pipeline A and the pipeline X and be collected by the vacuum pump 15 into the high-pressure buffer tank 8; after decomposition products flow out, closing the electric valves 5 on all the pipelines in the above steps;
step 2: seawater desalination;
1) generation of CO₂ hydrate by secondary hydrate generation tank 21;
opening the first electric valve 5 through which the pipeline XII passes, i.e. the valve located in front of an inlet of the gas booster pump 7; when a target injection volume is detected by the gas flowmeter 10 on the pipeline XII, opening the second electric valve 5 through which the pipeline XII passes, i.e. the valve located behind an outlet of high-pressure buffer tank 8, and injecting the gas primarily purified and collected in the high-pressure buffer tank 8 on the pipeline XII into the secondary hydrate generation tank 21; when a target injection volume is detected by the gas flowmeter 10 on the pipeline XII or a target pressure is detected by the pressure sensor 9 on the secondary hydrate generation tank 21, closing the electric valves 5 on the pipeline XII to stop gas injection;
at the same time, injecting the seawater in the seawater tank 4 into the secondary hydrate generation tank 21 under pressure through the high-pressure injection pump 11 and the electric valve 5 on the pipeline XXIX; when a target injection volume is detected by a liquid flowmeter 12 on the pipeline XXIX, closing the electric valve 5 on the pipeline XXIX to stop water injection;
at the same time, opening the electric valve 5 on the pipeline XVII, and making the second refrigeration unit 22 work continuously;
repeating the primary CO₂ hydrate generation process to conduct secondary purification;
when hydrate generation is finished, starting the vacuum pump 15, opening the electric valve 5 on the pipeline XXX, and discharging the residual exhaust gas in the secondary hydrate generation tank 21 through the electric valve 5 and the vacuum pump 15 (which is on the pipeline XXI), and the pipeline XXX;
2) hydrate transport;
after the concentration of secondarily purified CO₂ drops to a set value, sending a signal to the computer 28 by the CO₂ concentration sensor 14; activating the function of controlling hydrate transport, opening the electric valve 5 on the pipeline XVIII, and transporting the hydrate in the secondary hydrate generation tank 21 to the secondary hydrate decomposition tank 23;
when a pressure decrease is detected by the pressure sensor 9 in the secondary hydrate generation tank 21, opening the electric valves 5 on the pipeline II, the pipeline A, the pipeline X and the pipeline XII, starting the air compressor 1 and the vacuum pump 15 on the pipeline IX, repressurizing the secondary hydrate generation tank 21 by forward purification, and injecting the primarily purified gas into the secondary hydrate generation tank 21;
when the reading of the pressure sensor 9 on the secondary hydrate decomposition tank 23 is the same as that of the pressure sensor 9 on the secondary hydrate generation tank 21, closing the electric valves 5 on all the above mentioned pipelines to finish hydrate transport;
3) decomposition of CO₂ hydrate by secondary hydrate decomposition tank 23;
after the hydrate enters the secondary hydrate decomposition tank 23, starting the heat exchanger 19 and the high-pressure injection pump 11 (which is in the cold and energy storage system), and opening the first electric valve 5 on the pipeline XXVI through which high-temperature exhaust gas outflow passes; when a target injection volume is detected by the gas flowmeter 10 on the pipeline XXVI, closing the first electric valve 5 on the pipeline XXVI through which high-temperature exhaust gas outflow passes, opening the second electric valve 5 on the pipeline XXVI through which high-temperature exhaust gas outflow passes, and making high-temperature industrial exhaust gas flow out of the hot gas mixture tank 20 and enter the heat exchanger 19 through the pipeline XXVI; after heat exchange, making low-temperature industrial exhaust gas enter the gas mixture tank 2 through the pipeline XXV;
starting the high-pressure injection pump 11, pumping low-temperature circulating water in the second water tank 3-2 into the heat exchanger 19, opening the electric valve 5 on the pipeline XXVIII, and after heat exchange, making high-temperature circulating water enter a heat exchange coil in the secondary hydrate decomposition tank 23 through the pipeline XXVIII to provide heat energy for hydrate decomposition and accelerate hydrate decomposition reaction; after heat release is completed, making the low-temperature water return to the second water tank 3-2 through the pipeline XXXII;
repeating the primary CO₂ hydrate decomposition process to conduct secondary purification;
after the hydrate is transported to the secondary hydrate decomposition tank 23, opening the electric valve 5 prior to hydrate decomposition, and opening the electric valve 5 on the pipeline XXIV to recover the high-concentration brine recovered through the pipeline XXIV; opening the electric valve 5 on the pipeline B, starting the vacuum pump 15 on the pipeline XXI, decomposing the purified gas in the secondary hydrate decomposition tank 23, and making the gas flow through the pipeline B to be collected by the vacuum pump 15 into the high-pressure buffer tank 8; after decomposition products flow out, closing the electric valves 5 on all the above mentioned pipelines;
it should be noted that the pipeline C for gas replenishment and pressurization is added to the secondary hydrate decomposition tank 23, i.e. when the electric valve 5 on the pipeline XXIV is opened, opening the first electric valve 5 and the second electric valve 5 on the pipeline XXI through which the gas flowing out of a reactor passes, pumping the high-concentration CO₂ into the secondary hydrate decomposition tank 23 through the pipeline XXI and the pipeline C, and closing the above mentioned valves after pressurization is completed, i.e., after high-concentration seawater flows out completely.

### Implementation Example 4

The method for realizing CO₂ sequestration by the large-scale integrated device of CO₂ capture, sequestration and utilization, comprising the following steps:
storing the collected CO₂ in the high-pressure buffer tank 8 on the pipeline XXI, opening a third electric valve 5 on the pipeline XXI through which the gas flowing out of the reactor passes to allow CO₂ to be injected into the CO₂ sequestration tank 27, opening the second electric valves 5 on the pipeline XXII and the pipeline XXIII through which hydraulic oil outflow passes to make hydraulic oil enter the axial pressure tracking pump 25 or the peripheral pressure tracking pump 26 to work, and adjusting the working pressure of the pumps according to experimental and engineering requirements; when a target pressure is detected by a pressure sensor 9, opening the third electric valve 5 through which the oil filling pipelines pass, injecting the hydraulic oil into the CO₂ sequestration tank 27 to provide a pressurized environment, and controlling the opening and closing of the first electric valves 5 on the pipeline XXII and the pipeline XXIII through which hydraulic oil outflow passes to adjust the volume of the hydraulic oil in the oil tank 24.

The above mentioned embodiments only express several embodiments of the present invention, which are described in more specific and detailed, but are not to be construed as a limitation of the patent scope of the present invention. Technicians familiar with the field may also make various equivalent deformations without violating the spirit of the present application, and these equivalent deformations are included in the scope limited by the claims of the present application.

1. A large-scale integrated device of CO₂ capture, sequestration and utilization, comprising a gas compression system, a liquid injection system, a hydrate generation and decomposition system, a refrigeration circulation system, a cold and energy storage system, a sequestration simulation system, an automatic control system, and a seawater desalination system;
the gas compression system comprises an air compressor (1), a gas mixture tank (2), electric valves (5), check valves (6), gas booster pumps (7), high-pressure buffer tanks (8), pressure sensors (9), gas flowmeters (10), a pipeline I, a pipeline II, a pipeline VI, a pipeline VII, a pipeline XII, and a pipeline VIII; the air compressor (1) is connected to the corresponding gas booster pumps (7) through the pipeline I, the pipeline II and the pipeline VIII, respectively, and pipes connecting the pipeline I, the pipeline II and the pipeline VIII to the corresponding gas booster pumps (7) are provided with the electric valves (5); the front and rear ends of each gas booster pump (7) are connected to a check valve (6), respectively, to ensure one-way gas flow; the rear end of each gas booster pump (7) is connected to a high-pressure buffer tank (8) through the check valve (6), the upper end of the high-pressure buffer tank (8) is equipped with a pressure sensor (9) to monitor the pressure in the high-pressure buffer tank (8) in real time; the high-pressure buffer tank (8) is connected to a gas flowmeter (10) to record the flow rate of the gases flowing through in real time;
the liquid injection system comprises a first water tank (3-1), a high-pressure injection pump (11), liquid flowmeters (12), electric valves (5), a pipeline III, a pipeline IV, a pipeline V, and a pipeline XVI; the first water tank (3-1) is connected to the liquid flowmeters (12) and the electric valves (5) on the pipeline IV and the pipeline V through the high-pressure injection pump (11) on the pipeline III, respectively, to provide water for a primary hydrate generation tank (16) and a secondary hydrate generation tank (21), and the flow rate of the water is recorded at the same time; water generated by hydrate decomposition in a primary hydrate decomposition tank (18) and a secondary hydrate decomposition tank (23) flows back to the first water tank (3-1) through the pipeline XVI for water recycling;
the hydrate generation and decomposition system comprises the primary hydrate generation tank (16), the electric valves (5), the primary hydrate decomposition tank (18), the secondary hydrate generation tank (21), the secondary hydrate decomposition tank (23), pressure sensors (9), temperature sensors (13), CO₂ concentration sensors (14), vacuum pumps (15), high-pressure buffer tanks (8), a pipeline IX, a pipeline X, a pipeline VII, a pipeline XI, a pipeline XIV, a pipeline XVIII, a pipeline XV and a pipeline XIX; the pressure sensors (9), the temperature sensors (13) and the CO₂ concentration sensors (14) are connected to both the primary hydrate generation tank (16) and the secondary hydrate generation tank (21) to monitor the temperature, the pressure and the CO₂ concentration in the hydrate generation tanks in real time, respectively; the pressure sensors (9) and the temperature sensors (13) are connected to both the primary hydrate decomposition tank (18) and the secondary hydrate decomposition tank (23) to monitor the temperature and the pressure in the hydrate decomposition tanks in real time, respectively;
the primary hydrate generation tank (16) and secondary hydrate generation tank (21) are correspondingly connected to the primary hydrate decomposition tank (18) and secondary hydrate decomposition tank (23) through the pipeline XIV and the pipeline XVIII, respectively, for transporting hydrates generated by reaction; the pipeline XIV and the pipeline XVIII are provided with the electric valves (5);
the primary hydrate generation tank (16) and secondary hydrate generation tank (21) are connected to the pipeline IX and a pipeline XXI correspondingly and respectively, the pipeline IX and the pipeline XXI are provided with the electric valves (5) and the vacuum pumps (15) in sequence, and residual gases in the hydrate generation tanks are pumped out by the vacuum pumps (15); the vacuum pump (15) at the upper tail end of the pipeline IX is taken as a division node, and two branches are formed after passing through the vacuum pump (15); one branch is connected to the pipeline XI, and the tail end of the pipeline XI is connected to the atmosphere for forward purification; the other branch is connected to the pipeline X, the pipeline X is provided with the electric valves (5) and the high-pressure buffer tank (8) for reverse purification; two branches are formed after passing through the high-pressure buffer tank (8) at the tail end of the pipeline X, one branch goes upward and is connected to the gas booster pump (7) on the pipeline VII through an electric valve (5), and the other branch goes downward and is connected to the gas booster pump (7) on the pipeline XII through an electric valve (5); the pipeline XXI starts from the secondary hydrate generation tank (21), and the pipeline is provided with an electric valve (5), a vacuum pump (15), a high-pressure buffer tank (8) with a pressure sensor (9), an electric valve (5), a check valve (6), a gas booster pump (7), a check valve (6), a high-pressure buffer tank (8) with a pressure sensor (9), a gas flowmeter (10), and an electric valve (5) in sequence; the rear end of the vacuum pump (15) on the pipeline XXI is connected to a pipeline XXX to be used as a final outlet of the residual gases in the secondary hydrate generation tank (21);
the primary hydrate generation tank (16) is connected to the secondary hydrate generation tank (21) through the pipeline IX, the pipeline X, and the pipeline XII (which is in the gas compression system) in sequence to transport the residual gases in the primary hydrate generation tank (16) to the secondary hydrate generation tank (21) for further reaction, and thus to complete the gas injection of the secondary hydrate generation tank (21);
the bottom of the primary hydrate decomposition tank (18) is connected to the pipeline XV and the pipeline A, respectively, through an electric valve (5), with the pipeline XV being used for discharging non-CO₂ gases and the pipeline A being used for discharging CO₂;
the bottom of the secondary hydrate decomposition tank (23) is connected to the pipeline XIX and the pipeline B, respectively, through an electric valve (5), with the pipeline XIX being used for discharging non-CO₂ gases and the pipeline B being used for discharging CO₂;
during hydrate generation, due to the continuous consumption of gases, it is necessary to carry out repressurization in four lines, which is respectively to:
repressurize the primary hydrate generation tank (16) by forward purification: the gas mixture tank (2) is connected to the primary hydrate generation tank (16) through the pipeline VI in the gas compression system to complete repressurization;
repressurize the secondary hydrate generation tank (21) by forward purification: the primary hydrate decomposition tank (18) is connected to the secondary hydrate generation tank (21) through the pipeline A, the vacuum pump (15) on the pipeline IX, the pipeline X, and the pipeline XII (which is in the gas compression system) in sequence to complete repressurization;
repressurize the primary hydrate generation tank (16) by reverse purification: the primary hydrate generation tank (16) is connected to the pipeline IX, the pipeline X, the pipeline VII (which is in the gas compression system), and then back to the primary hydrate generation tank (16) in sequence to complete repressurization; further, CO₂ with a certain pressure is pre-stored in the high pressure buffer tank (8) on the pipeline X;
repressurize the secondary hydrate generation tank (21) by reverse purification: the primary hydrate generation tank (16) is connected to the secondary hydrate generation tank (21) through the pipeline IX, the pipeline X, and the pipeline XII in (which is the gas compression system) in sequence to complete repressurization;
an outlet of pipeline A is connected to an inlet end of the vacuum pump (15) on the pipeline IX and is merged into the pipeline X after passing through the vacuum pump (15);
the hydrate refrigeration circulation system comprises a first refrigeration unit (17), a second refrigeration unit (22), a pipeline XIII and a pipeline XVII, and is used to provide a cooling capacity required for hydrate generation; the first refrigeration unit (17) and the second refrigeration unit (22) are connected to the primary hydrate generation tank (16) and the secondary hydrate generation tank (21) through the pipeline XIII and the pipeline XVII, respectively, and the pipeline XIII and the pipeline XVII are provided with electric valves (5);
the cold and energy storage system comprises a hot gas mixture tank (20), electric valves (5), a check valve (6), a gas booster pump (7), a gas flowmeter (10), a heat exchanger (19), a high-pressure injection pump (11), a second water tank (3-2), temperature sensors (13), a pipeline XXV, a pipeline XXVI, a pipeline XXVII, a pipeline XXVIII, a pipeline XXXI and a pipeline XXXII; high-temperature gases in the hot gas mixture tank (20) pass through an electric valve (5), the gas booster pump (7), the gas flowmeter (10) and an electric valve (5) in sequence and then enter the heat exchanger (19) to heat the water from the second water tank (3-2), and cold gases after being cooled down in the heat exchanger (19) are transported to the gas mixture tank (2) through the pipeline XXV; the high-pressure injection pump (11) is located on the pipeline XXVII, water from the second water tank (3-2) passes through the high-pressure injection pump (11) and enters the heat exchanger (19) to be heated and then transported to a water outlet of the heat exchanger (19), the water outlet of the heat exchanger (19) is divided into two branches, one branch is the pipeline XXXI which is provided with an electric valve (5) and a temperature sensor (13), the tail end of the pipeline XXXI is connected to the primary hydrate decomposition tank (18), and the water is returned to the second water tank (3-2) through the pipeline XXVII with a temperature sensor (13) after heat release is completed in a coil of the primary hydrate decomposition tank (18); the other branch is the pipeline XXVIII which is connected before the electric valve (5) on the pipeline XXXI, the pipeline XXVIII is also provided with an electric valve (5) and a temperature sensor (13), the tail end of the pipeline XXVIII is connected to the secondary hydrate decomposition tank (23), and the water is returned to the second water tank (3-2) through the pipeline XXXII with a temperature sensor (13) after heat release is completed in a coil of the secondary hydrate decomposition tank (23);
the sequestration simulation system comprises pressure sensors (9), a temperature sensor (13), a CO₂ sequestration tank (27), an oil tank (24), an axial pressure tracking pump (25), a peripheral pressure tracking pump (26), a CO₂ sequestration tank (27), the pipeline XXI, a pipeline XXII and a pipeline XXIII;
high-concentration CO₂ enters the CO₂ sequestration tank (27) through the pipeline XXI, and the high-concentration CO₂ is from two sources:
source 1: the high-concentration CO₂ is discharged from the secondary hydrate decomposition tank (23) and merged into the pipeline XXI through the pipeline B, and the tail end of the pipeline B is connected to an inlet of the vacuum pump (15) on the pipeline XXI;
source 2: the high-concentration CO₂ is discharged from the secondary hydrate generation tank (21) and enters the pipeline XXI directly;
the CO₂ sequestration tank (27) is provided with a pressure sensor (9) and the temperature sensor (13) to monitor the temperature and the pressure in the CO₂ sequestration tank (27) in real time;
the pipeline XXII is provided with an electric valve (5), an oil tank (24-1), an electric valve (5), the axial pressure tracking pump (25) with a pressure sensor (9), and an electric valve (5) in sequence, and is then connected to the CO₂ sequestration tank (27);
the pipeline XXIII is provided with an electric valve (5), an oil tank (24-2), an electric valve (5), the peripheral pressure tracking pump (26) with a pressure sensor (9), and an electric valve (5) in sequence, and is then connected to the CO₂ sequestration tank (27);
the automatic control system comprises a computer (28), a display, a touch screen and an interface;
the seawater desalination system comprises a seawater tank (4), a pipeline XXIX, a high-pressure injection pump (11), electric valves (5), a pipeline XXIV, a pipeline XX and a pipeline C; seawater is injected into the secondary hydrate generation tank (21) under pressure through the high-pressure injection pump (11) and the electric valve (5) on pipeline XXIX, generated hydrates and high-concentration brine enter the secondary hydrate decomposition tank (23) through the pipeline XVIII together, and prior to hydrate decomposition in the secondary hydrate decomposition tank (23), the high-concentration brine is recovered through the pipeline XXIV; the lower part of the secondary hydrate decomposition tank (23) is connected to the pipeline C, and after the pipeline C is connected to the gas flowmeter (10) on the pipeline XXI, the secondary hydrate decomposition tank (23) is repressurized by the high-concentration CO₂ in the high-pressure buffer tank (8) on the pipeline XXI to make the high-concentration brine flow out smoothly, and fresh water generated after hydrate decomposition flows back to the first tank (3-1) through the pipeline XX and the pipeline XVI.

2. The large-scale integrated device of CO₂ capture, sequestration and utilization according to claim 1, wherein the liquid injection system is divided into three lines:
the first water tank (3-1) is connected to the liquid flowmeter (12) and the electric valve (5) on the pipeline V through the high-pressure injection pump (11) on the pipeline III to provide water for a primary hydrate generation tank (16), and this line is a water injection line for the primary hydrate generation tank (16);
the first water tank (3-1) is connected to the liquid flowmeter (12) and the electric valve (5) on the pipeline IV through the high-pressure injection pump (11) on the pipeline III to provide water for a secondary hydrate generation tank (21), and this line is a water injection line for the secondary hydrate generation tank (21);
the seawater in the seawater tank (4) is injected into the secondary hydrate generation tank (21) under pressure through the high-pressure injection pump (11) and the electric valve (5) on the pipeline XXIX, and the liquid flowmeter (12) and the electric valve (5) on the pipeline IV, and this line is a seawater injection line for the secondary hydrate generation tank (21).

3. A method for realizing two-stage forward purification of CO₂ from hydrates by the large-scale integrated device of CO₂ capture, sequestration and utilization according to claim 1, comprising the following steps:
step 1: generation of CO₂ hydrate by primary hydrate generation tank (16);
starting the air compressor (1), opening the electric valve (5) on the pipeline I and the first electric valve (5) on the pipeline VI through which gas mixture outflow passes, and pumping the gas mixture in the gas mixture tank (2) into the high-pressure buffer tank (8) through the gas booster pump (7); when the pressure detected by the pressure sensor (9) on the high-pressure buffer tank (8) is stable, opening the second electric valve (5) on the pipeline VI through which gas mixture outflow passes, and pumping the gas mixture in the high-pressure buffer tank (8) into the primary hydrate generation tank (16); when a target injection volume is detected by the gas flowmeter (10) on the pipeline VI or a target pressure is detected by the pressure sensor (9) on the primary hydrate generation tank (16), closing the electric valves (5) on the pipeline, and shutting down the air compressor (1) to stop gas injection;
at the same time, opening the electric valve (5) on the pipeline V, injecting the water in the first water tank (3-1) into the primary hydrate generation tank (16) by the high-pressure injection pump (11) through the pipeline III and the pipeline V; when a target injection volume is detected by a liquid flowmeter (12) on the pipeline V, closing the electric valve (5) on the pipeline V to stop water injection;
at the same time, opening the electric valve (5) on the pipeline XIII, and making the first refrigeration unit (17) work continuously to provide cooling water for a water cooling jacket of the primary hydrate generation tank (16), so as to ensure that the temperature of the primary hydrate generation tank (16) is constant at the hydrate reaction temperature;
when hydrate generation begins, making the water react with the CO₂ in the gas mixture to generate CO₂ hydrate, thus to separate the CO₂ in the gas mixture; however, in this process, a small amount of hydrates will also be generated by some impurity gases;
when hydrate generation is finished, opening the electric valves (5) on the pipeline IX and the pipeline XI, and discharging the residual exhaust gas in the generation tank through the pipeline IX and the pipeline XI;
step 2: hydrate transport;
after the concentration of primarily purified CO₂ drops to a set value, sending a signal to the computer (28) by the CO₂ concentration sensor (14), activating the function of controlling hydrate transport, opening the electric valve (5) on the pipeline XIV, and transporting the hydrate in the primary hydrate generation tank (16) to the primary hydrate decomposition tank (18);
when a pressure decrease is detected by the pressure sensor (9) in the primary hydrate generation tank (16), opening the electric valve (5) on the pipeline I and the first electric valve (5) on the pipeline VI through which gas mixture outflow passes, and repressurizing the primary hydrate generation tank (16) by forward purification to maintain the reaction pressure in the primary hydrate generation tank (16);
since the volume of the hydrate generation tank is greater than that of the hydrate decomposition tank, hydrate transport will be promoted by the inlet repressurization process, and at the same time, residual hydrate slurry in the hydrate generation tank will play a function of inducing subsequent hydrate generation;
when the reading of the pressure sensor (9) on the primary hydrate decomposition tank (18) is the same as that of the pressure sensor (9) on the primary hydrate generation tank (16), closing the electric valves (5) on all the above mentioned pipelines to finish hydrate transport;
step 3: decomposition of CO₂ hydrate by primary hydrate decomposition tank (18);
after the hydrate enters the primary hydrate decomposition tank (18), starting the heat exchanger (19) and the high-pressure injection pump (11) (which is in the cold and energy storage system), and opening the first electric valve (5) on the pipeline XXVI through which high-temperature exhaust gas outflow passes; when a target injection volume is detected by the gas flowmeter (10) on the pipeline XXVI, closing the first electric valve (5) on the pipeline XXVI through which high-temperature exhaust gas outflow passes, opening the second electric valve (5) on the pipeline XXVI through which high-temperature exhaust gas outflow passes, and making high-temperature industrial exhaust gas flow out of the hot gas mixture tank (20) and enter the heat exchanger (19) through the pipeline XXVI; after heat exchange, making low-temperature industrial exhaust gas enter the gas mixture tank (2) through the pipeline XXV;
starting the high-pressure injection pump (11), pumping low-temperature circulating water in the second water tank (3-2) into the heat exchanger (19), opening the electric valve (5) on the pipeline XXXI, and after heat exchange, making high-temperature circulating water enter a heat exchange coil in the primary hydrate decomposition tank (18) through the pipeline XXXI to provide heat energy for hydrate decomposition and accelerate hydrate decomposition reaction; after heat release is completed, making the low-temperature water return to the second water tank (3-2) through the pipeline XXVII;
generating water and CO₂ after the decomposition of the CO₂ hydrate in the primary hydrate decomposition tank (18); when a target parameter is detected by the pressure sensor (9) or the temperature sensor (13) on the primary hydrate decomposition tank (18), opening the electric valve (5) on the pipeline XVI, making the water flow back to the first tank (3-1) through the pipeline XVI, opening the electric valve (5) on the pipeline X, and making the gas flow through the pipeline A and the pipeline X and be collected by the vacuum pump (15) into the high-pressure buffer tank (8); after decomposition products flow out, closing the electric valves (5) on all the pipelines in the above steps;
step 4: generation of CO₂ hydrate by secondary hydrate generation tank (21);
opening the first electric valve (5) through which the pipeline XII passes, i.e. the valve located in front of an inlet of the gas booster pump (7); when a target injection volume is detected by the gas flowmeter (10) on the pipeline XII, opening the second electric valve (5) through which the pipeline XII passes, i.e. the valve located behind an outlet of high-pressure buffer tank (8), and injecting the gas primarily purified and collected in the high-pressure buffer tank (8) on the pipeline XII into the secondary hydrate generation tank (21); when a target injection volume is detected by the gas flowmeter (10) on the pipeline XII or a target pressure is detected by the pressure sensor (9) on the secondary hydrate generation tank (21), closing the electric valves (5) on the pipeline XII to stop gas injection; at the same time, starting the high-pressure injection pump (11), opening the electric valve (5) on the pipeline IV, injecting the water in the first water tank (3-1) into the primary hydrate generation tank (16) by the high-pressure injection pump (11) through the pipeline III and the pipeline IV; when a target injection volume is detected by a liquid flowmeter (12) on the pipeline IV, closing the electric valve (5) on the pipeline IV to stop water injection; at the same time, opening the electric valve (5) on the pipeline XVII, and making the second refrigeration unit (22) work continuously;
repeating the primary CO₂ hydrate generation process to conduct secondary purification;
when hydrate generation is finished, starting the vacuum pump (15), opening the electric valve (5) on the pipeline XXX, and discharging the residual exhaust gas in the secondary hydrate generation tank (21) through the electric valve (5) and the vacuum pump (15) on the pipeline XXI, and the pipeline XXX;
step 5: hydrate transport;
after the concentration of secondarily purified CO₂ drops to a set value, sending a signal to the computer (28) by the CO₂ concentration sensor (14); activating the function of controlling hydrate transport, opening the electric valve (5) on the pipeline XVIII, and transporting the hydrate in the secondary hydrate generation tank (21) to the secondary hydrate decomposition tank (23);
when a pressure decrease is detected by the pressure sensor (9) in the secondary hydrate generation tank (21), opening the electric valves (5) on the pipeline II, the pipeline A, the pipeline X and the pipeline XII, starting the air compressor (1) and the vacuum pump (15) (which is on the pipeline IX), repressurizing the secondary hydrate generation tank (21) by forward purification, and injecting the primarily purified gas into the secondary hydrate generation tank (21);
when the reading of the pressure sensor (9) on the secondary hydrate decomposition tank (23) is the same as that of the pressure sensor (9) on the secondary hydrate generation tank (21), closing the electric valves (5) on all the above mentioned pipelines to finish hydrate transport;
step 6: decomposition of CO₂ hydrate by secondary hydrate decomposition tank (23);
after the hydrate enters the secondary hydrate decomposition tank (23), starting the heat exchanger (19) and the high-pressure injection pump (11) (which is in the cold and energy storage system), and opening the first electric valve (5) on the pipeline XXVI through which the high-temperature exhaust gas passes; when a target injection volume is detected by the gas flowmeter (10) on the pipeline XXVI, closing the first electric valve (5) on the pipeline XXVI through which the high-temperature exhaust gas passes, opening the second electric valve (5) on the pipeline XXVI through which the high-temperature exhaust gas passes, and making high-temperature industrial exhaust gas flow out of the hot gas mixture tank (20) and enter the heat exchanger (19) through the pipeline XXVI; after heat exchange, making low-temperature industrial exhaust gas enter the gas mixture tank (2) through the pipeline XXV;
starting the high-pressure injection pump (11), pumping low-temperature circulating water in the second water tank (3-2) into the heat exchanger (19), opening the electric valve (5) on the pipeline XXVIII, and after heat exchange, making high-temperature circulating water enter a heat exchange coil in the secondary hydrate decomposition tank (23) through the pipeline XXVIII to provide heat energy for hydrate decomposition and accelerate hydrate decomposition reaction; after heat release is completed, making the low-temperature water return to the second water tank (3-2) through the pipeline XXXII;
repeating the primary CO₂ hydrate decomposition process to conduct secondary purification;
generating water and CO₂ after the decomposition of the CO₂ hydrate in the secondary hydrate decomposition tank (23), opening the electric valve (5) on the pipeline XX, and making the water flow back to the first tank (3-1) through the pipeline XX and the pipeline XVI; opening the electric valve (5) on the pipeline B, starting the vacuum pump (15) on the pipeline XXI, decomposing the purified gas in the secondary hydrate decomposition tank (23), and making the gas flow through the pipeline B to be collected by the vacuum pump (15) into the high-pressure buffer tank (8); after decomposition products flow out, closing the electric valves (5) on all the above mentioned pipelines.

4. The method according to claim 1, wherein the large-scale integrated device of CO₂ capture, sequestration and utilization is also used in a method for realizing reverse purification of CO₂ from hydrates, comprising the following steps:
step 1: generation of non-CO₂ hydrates by primary hydrate generation tank (16);
starting the air compressor (1), opening the electric valve (5) on the pipeline I and the first electric valve (5) on the pipeline VI through which the gas mixture passes, and pumping the gas mixture in the gas mixture tank (2) into the high-pressure buffer tank (8) through the gas booster pump (7); when the pressure detected by the pressure sensor (9) on the high-pressure buffer tank (8) is stable, opening the second electric valve (5) on the pipeline VI through which the gas mixture passes, and pumping the gas mixture in the high-pressure buffer tank (8) into the primary hydrate generation tank (16); when a target injection volume is detected by the gas flowmeter (10) on the pipeline VI or a target pressure is detected by the pressure sensor (9) on the primary hydrate generation tank (16), closing the electric valves (5) on the pipeline, and shutting down the air compressor (1) to stop gas injection;
at the same time, opening the electric valve (5) on the pipeline V, injecting the water in the first water tank (3-1) into the primary hydrate generation tank (16) by the high-pressure injection pump (11) through the pipeline III and the pipeline V; when a target injection volume is detected by a liquid flowmeter (12) on the pipeline V, closing the electric valve (5) on the pipeline V to stop water injection;
at the same time, opening the electric valve (5) on the pipeline XIII, and making the first refrigeration unit (17) work continuously to provide cooling water for a water cooling jacket of the primary hydrate generation tank (16), so as to ensure that the temperature of the primary hydrate generation tank (16) is constant at the hydrate reaction temperature;
when hydrate generation begins, making pure water react with non-CO₂ gases in the gas mixture to generate hydrates, and high-concentration CO₂ and some impurity gases will be left in the tank; when hydrate generation is finished, opening the electric valve (5) on the pipeline IX, pumping the high-concentration CO₂ and some impurity gases through the pipeline IX into the high-pressure buffer tank (8) to make preparation for secondary purification;
step 2: hydrate transport;
after the concentration of primarily purified CO₂ drops to a set value, sending a signal to the computer (28) by the CO₂ concentration sensor (14), activating the function of controlling hydrate transport, opening the electric valve (5) on the pipeline XIV, and transporting the hydrate in the primary hydrate generation tank (16) to the primary hydrate decomposition tank (18);
when a pressure decrease is detected by the pressure sensor (9) in the hydrates in the primary hydrate generation tank (16), carrying out inlet repressurization to the primary hydrate generation tank (16) by reverse purification, with the specific process as follows:
during initial operation, opening the electric valve (5) on the pipeline VIII and the second electric valve (5) through which the pipeline VII passes, i.e. the valve located behind an outlet of high-pressure buffer tank (8), pre-storing CO₂ with a certain pressure in the high-pressure buffer tank (8), and pumping high-concentration CO₂ and some impurity gases into the primary hydrate generation tank (16) through the gas booster pump (7) to maintain the reaction pressure in the primary hydrate generation tank (16);
during subsequent operation, opening the electric valves (5) on the pipeline VIII, the pipeline IX and the pipeline X, opening the first electric valve (5) through which the pipeline VII passes, i.e. the valve located in front of an inlet of the gas booster pump (7), and pumping the high-concentration CO₂ and some impurity gases into the high-pressure buffer tank (8); when the pressure detected by the pressure sensor (9) is stable, opening the second electric valve (5) through which the pipeline VII passes, i.e. the valve located behind an outlet of high-pressure buffer tank (8), pumping the high-concentration CO₂ and some impurity gases into the primary hydrate generation tank (16) through the gas booster pump (7) to maintain the reaction pressure in the primary hydrate generation tank (16);
since the volume of the hydrate generation tank is greater than that of the hydrate decomposition tank, hydrate transport will be promoted by the inlet repressurization process, and at the same time, residual hydrate slurry in the hydrate generation tank will play a function of inducing subsequent hydrate generation;
when the reading of the pressure sensor (9) on the primary hydrate decomposition tank (18) is the same as that of the pressure sensor (9) on the primary hydrate generation tank (16), closing the electric valves (5) on all the above mentioned pipelines to finish hydrate transport;
step 3: decomposition of non-CO₂ hydrates by primary hydrate decomposition tank (18);
after the hydrate enters the primary hydrate decomposition tank (18), starting the heat exchanger (19) and the high-pressure injection pump (11) (which is in the cold and energy storage system), and opening the first electric valve (5) on the pipeline XXVI through which the high-temperature exhaust gas passes; when a target injection volume is detected by the gas flowmeter (10) on the pipeline XXVI, closing the first electric valve (5) on the pipeline XXVI through which the high-temperature exhaust gas passes, opening the second electric valve (5) through which the high-temperature exhaust gas passes, and making high-temperature industrial exhaust gas flow out of the hot gas mixture tank (20) and enter the heat exchanger (19) through the pipeline XXVI; after heat exchange, making low-temperature industrial exhaust gas enter the gas mixture tank (2) through the pipeline XXV;
starting the high-pressure injection pump (11), pumping low-temperature circulating water in the second water tank (3-2) into the heat exchanger (19), opening the electric valve (5) on the pipeline XXXI, and after heat exchange, making high-temperature circulating water enter a heat exchange coil in the primary hydrate decomposition tank (18) through the pipeline XXXI to provide heat energy for hydrate decomposition and accelerate hydrate decomposition reaction; after heat release is completed, making the low-temperature water return to the second water tank (3-2) through the pipeline XXVII;
generating water and CO₂ after the decomposition of the non-CO₂ hydrates in the primary hydrate decomposition tank (18); when a target parameter is detected by the pressure sensor (9) or the temperature sensor (13) on the primary hydrate decomposition tank (18), discharging gases by the following steps: opening the electric valve (5) on the pipeline XV, and discharging the gases generated by decomposition in the primary hydrate decomposition tank (18) into the atmosphere through the pipeline XV;
after decomposition products flow out, closing the electric valves (5) on all the pipelines in the above steps;
step 4: generation of non-CO₂ hydrates by secondary hydrate generation tank (21);
opening the first electric valve (5) through which the pipeline XII passes, i.e. the valve located in front of an inlet of the gas booster pump (7); when a target injection volume is detected by the gas flowmeter (10) on the pipeline XII, opening the second electric valve (5) through which the pipeline XII passes, i.e. the valve located behind an outlet of high-pressure buffer tank (8), and injecting the gas primarily purified and collected in the high-pressure buffer tank (8) on the pipeline XII into the secondary hydrate generation tank (21); when hydrate generation begins, making pure water react with non-CO₂ gases in the gas mixture to generate hydrates, and high-concentration CO₂ will be left in the secondary hydrate generation tank (21); when a target injection volume is detected by the gas flowmeter (10) on the pipeline XII or a target pressure is detected by the pressure sensor (9) on the secondary hydrate generation tank (21), closing the electric valves (5) on the pipeline XII to stop gas injection;
at the same time, starting the high-pressure injection pump (11), opening the electric valve (5) on the pipeline IV, injecting the water in the first water tank (3-1) into the primary hydrate generation tank (16) by the high-pressure injection pump (11) through the pipeline III and the pipeline IV; when a target injection volume is detected by a liquid flowmeter (12) on the pipeline IV, closing the electric valve (5) on the pipeline IV to stop water injection;
at the same time, opening the electric valve (5) on the pipeline XVII, and making the second refrigeration unit (22) work continuously;
repeating the primary non-CO₂ hydrate generation process to conduct secondary purification;
collecting secondarily purified CO₂ into the high-pressure buffer tank (8) by the vacuum pump (15) on the pipeline XXI;
step 5: hydrate transport;
after the concentration of secondarily purified CO₂ drops to a set value, sending a signal to the computer (28) by the CO₂ concentration sensor (14); activating the function of controlling hydrate transport, opening the electric valve (5) on the pipeline XVIII, and transporting the hydrate in the secondary hydrate generation tank (21) to the secondary hydrate decomposition tank (23);
when a pressure decrease is detected by the pressure sensor (9) in the secondary hydrate generation tank (21), repressurizing the secondary hydrate generation tank (21) by reverse purification, with the specific process as follows: opening the electric valves (5) on the pipeline II and the pipeline XII, starting the air compressor (1), and injecting the gases purified and collected in the high-pressure buffer tank (8) on the pipeline X into the secondary hydrate generation tank (21) through the pipeline XII;
when the reading of the pressure sensor (9) on the secondary hydrate decomposition tank (23) is the same as that of the pressure sensor (9) on the secondary hydrate generation tank (21), closing the electric valves (5) on all the above mentioned pipelines to finish hydrate transport;
step 6: decomposition of non-CO₂ hydrates by secondary hydrate decomposition tank (23);
after the hydrate enters the secondary hydrate decomposition tank (23), starting the heat exchanger (19) and the high-pressure injection pump (11) (which is in the cold and energy storage system), and opening the first electric valve (5) on the pipeline XXVI through which the high-temperature exhaust gas passes; when a target injection volume is detected by the gas flowmeter (10) on the pipeline XXVI, closing the first electric valve (5) on the pipeline XXVI through which the high-temperature exhaust gas passes, opening the second electric valve (5) on the pipeline XXVI through which the high-temperature exhaust gas passes, and making high-temperature industrial exhaust gas flow out of the hot gas mixture tank (20) and enter the heat exchanger (19) through the pipeline XXVI; after heat exchange, making low-temperature industrial exhaust gas enter the gas mixture tank (2) through the pipeline XXV;
starting the high-pressure injection pump (11), pumping low-temperature circulating water in the second water tank (3-2) into the heat exchanger (19), opening the electric valve (5) on the pipeline XXVIII, and after heat exchange, making high-temperature circulating water enter a heat exchange coil in the secondary hydrate decomposition tank (23) through the pipeline XXVIII to provide heat energy for hydrate decomposition and accelerate hydrate decomposition reaction; after heat release is completed, making the low-temperature water return to the second water tank (3-2) through the pipeline XXXII;
repeating the primary non-CO₂ hydrate decomposition process to conduct secondary purification;
generating water and CO₂ after the decomposition of the CO₂ hydrate in the secondary hydrate decomposition tank (23), opening the electric valve (5) on the pipeline XX, and making the water flow back to the first tank (3-1) through the pipeline XX; opening the electric valve (5) on the pipeline B, and starting the vacuum pump (15) on the pipeline XXI;
generating water and non-CO₂ gases after the decomposition of the non-CO₂ hydrates in the secondary hydrate decomposition tank (23), and discharging the gases into the atmosphere through the pipeline XIX;
after decomposition products flow out, closing the electric valves (5) on all the above mentioned pipelines.

5. A method for realizing forward purification of CO₂ from hydrates and desalinating seawater by the large-scale integrated device of CO₂ capture, sequestration and utilization according to claim 1, comprising the following steps:
step 1: primary purification of CO₂;
1) generation of CO₂ hydrate by primary hydrate generation tank (16);
starting the air compressor (1), opening the electric valve (5) on the pipeline I and the first electric valve (5) on the pipeline VI through which the gas mixture passes, and pumping the gas mixture in the gas mixture tank (2) into the high-pressure buffer tank (8) through the gas booster pump (7); when the pressure detected by the pressure sensor (9) on the high-pressure buffer tank (8) is stable, opening the second electric valve (5) on the pipeline VI through which the gas mixture passes, and pumping the gas mixture in the high-pressure buffer tank (8) into the primary hydrate generation tank (16); when a target injection volume is detected by the gas flowmeter (10) on the pipeline VI or a target pressure is detected by the pressure sensor (9) on the primary hydrate generation tank (16), closing the electric valves (5) on the pipeline, and shutting down the air compressor (1) to stop gas injection;
at the same time, opening the electric valve (5) on the pipeline V, injecting the water in the first water tank (3-1) into the primary hydrate generation tank (16) by the high-pressure injection pump (11) through the pipeline III and the pipeline V; when a target injection volume is detected by a liquid flowmeter (12) on the pipeline V, closing the electric valve (5) on the pipeline V to stop water injection;
at the same time, opening the electric valve (5) on the pipeline XIII, and making the first refrigeration unit (17) work continuously to provide cooling water for a water cooling jacket of the primary hydrate generation tank (16), so as to ensure that the temperature of the primary hydrate generation tank (16) is constant at the hydrate reaction temperature;
when hydrate generation begins, making the water react with the CO₂ in the gas mixture to generate CO₂ hydrate, thus to separate the CO₂ in the gas mixture; however, in this process, a small amount of hydrates will also be generated by some impurity gases;
when hydrate generation is finished, opening the electric valves (5) on the pipeline IX and the pipeline XI, and discharging the residual exhaust gas in the generation tank through the pipeline IX and the pipeline XI;
2) hydrate transport;
after the concentration of primarily purified CO₂ drops to a set value, sending a signal to the computer (28) by the CO₂ concentration sensor (14), activating the function of controlling hydrate transport, opening the electric valve (5) on the pipeline XIV, and transporting the hydrate in the primary hydrate generation tank (16) to the primary hydrate decomposition tank (18);
when a pressure decrease is detected by the pressure sensor (9) in the primary hydrate generation tank (16), opening the electric valve (5) on the pipeline I and the first electric valve (5) on the pipeline VI through which the gas mixture passes, and repressurizing the primary hydrate generation tank (16) by forward purification to maintain the reaction pressure in the primary hydrate generation tank (16);
since the volume of the hydrate generation tank is greater than that of the hydrate decomposition tank, hydrate transport will be promoted by the inlet repressurization process, and at the same time, residual hydrate slurry in the hydrate generation tank will play a function of inducing subsequent hydrate generation;
when the reading of the pressure sensor (9) on the primary hydrate decomposition tank (18) is the same as that of the pressure sensor (9) on the primary hydrate generation tank (16), closing the electric valves (5) on all the above mentioned pipelines to finish hydrate transport;
3) decomposition of CO₂ hydrate by primary hydrate decomposition tank (18);
after the hydrate enters the primary hydrate decomposition tank (18), starting the heat exchanger (19) and the high-pressure injection pump (11) in the cold and energy storage system, and opening the first electric valve (5) on the pipeline XXVI through which the high-temperature exhaust gas passes; when a target injection volume is detected by the gas flowmeter (10) on the pipeline XXVI, closing the first electric valve (5) on the pipeline XXVI through which the high-temperature exhaust gas passes, opening the second electric valve (5) on the pipeline XXVI through which the high-temperature exhaust gas passes, and making high-temperature industrial exhaust gas flow out of the hot gas mixture tank (20) and enter the heat exchanger (19) through the pipeline XXVI; after heat exchange, making low-temperature industrial exhaust gas enter the gas mixture tank (2) through the pipeline XXV;
starting the high-pressure injection pump (11), pumping low-temperature circulating water in the second water tank (3-2) into the heat exchanger (19), opening the electric valve (5) on the pipeline XXXI, and after heat exchange, making high-temperature circulating water enter a heat exchange coil in the primary hydrate decomposition tank (18) through the pipeline XXXI to provide heat energy for hydrate decomposition and accelerate hydrate decomposition reaction; after heat release is completed, making the low-temperature water return to the second water tank (3-2) through the pipeline XXVII;
generating water and CO₂ after the decomposition of the CO₂ hydrate in the primary hydrate decomposition tank (18); when a target parameter is detected by the pressure sensor (9) or the temperature sensor (13) on the primary hydrate decomposition tank (18), opening the electric valve (5) on the pipeline XVI, making the water flow back to the first tank (3-1) through the pipeline XVI, opening the electric valve (5) on the pipeline X, and making the gas flow through the pipeline A and the pipeline X and be collected by the vacuum pump (15) into the high-pressure buffer tank (8); after decomposition products flow out, closing the electric valves (5) on all the pipelines in the above steps;
step 2: seawater desalination;
1) generation of CO₂ hydrate by secondary hydrate generation tank (21);
opening the first electric valve (5) through which the pipeline XII passes, i.e. the valve located in front of an inlet of the gas booster pump (7); when a target injection volume is detected by the gas flowmeter (10) on the pipeline XII, opening the second electric valve (5) through which the pipeline XII passes, i.e. the valve located behind an outlet of high-pressure buffer tank (8), and injecting the gas primarily purified and collected in the high-pressure buffer tank (8) on the pipeline XII into the secondary hydrate generation tank (21); when a target injection volume is detected by the gas flowmeter (10) on the pipeline XII or a target pressure is detected by the pressure sensor (9) on the secondary hydrate generation tank (21), closing the electric valves (5) on the pipeline XII to stop gas injection;
at the same time, injecting the seawater in the seawater tank (4) into the secondary hydrate generation tank (21) under pressure through the high-pressure injection pump (11) and the electric valve (5) on the pipeline XXIX; when a target injection volume is detected by a liquid flowmeter (12) on the pipeline XXIX, closing the electric valve (5) on the pipeline XXIX to stop water injection;
at the same time, opening the electric valve (5) on the pipeline XVII, and making the second refrigeration unit (22) work continuously;
repeating the primary CO₂ hydrate generation process to conduct secondary purification;
when hydrate generation is finished, starting the vacuum pump (15), opening the electric valve (5) on the pipeline XXX, and discharging the residual exhaust gas in the secondary hydrate generation tank (21) through the electric valve (5) and the vacuum pump (15) (which is on the pipeline XXI), and the pipeline XXX;
2) hydrate transport;
after the concentration of secondarily purified CO₂ drops to a set value, sending a signal to the computer (28) by the CO₂ concentration sensor (14); activating the function of controlling hydrate transport, opening the electric valve (5) on the pipeline XVIII, and transporting the hydrate in the secondary hydrate generation tank (21) to the secondary hydrate decomposition tank (23);
when a pressure decrease is detected by the pressure sensor (9) in the secondary hydrate generation tank (21), opening the electric valves (5) on the pipeline II, the pipeline A, the pipeline X and the pipeline XII, starting the air compressor (1) and the vacuum pump (15) on the pipeline IX, repressurizing the secondary hydrate generation tank (21) by forward purification, and injecting the primarily purified gas into the secondary hydrate generation tank (21);
when the reading of the pressure sensor (9) on the secondary hydrate decomposition tank (23) is the same as that of the pressure sensor (9) on the secondary hydrate generation tank (21), closing the electric valves (5) on all the above mentioned pipelines to finish hydrate transport;
3) decomposition of CO₂ hydrate by secondary hydrate decomposition tank (23);
after the hydrate enters the secondary hydrate decomposition tank (23), starting the heat exchanger (19) and the high-pressure injection pump (11) (which is in the cold and energy storage system), and opening the first electric valve (5) on the pipeline XXVI through which high-temperature exhaust gas outflow passes; when a target injection volume is detected by the gas flowmeter (10) on the pipeline XXVI, closing the first electric valve (5) on the pipeline XXVI through which high-temperature exhaust gas outflow passes, opening the second electric valve (5) on the pipeline XXVI through which high-temperature exhaust gas outflow passes, and making high-temperature industrial exhaust gas flow out of the hot gas mixture tank (20) and enter the heat exchanger (19) through the pipeline XXVI; after heat exchange, making low-temperature industrial exhaust gas enter the gas mixture tank (2) through the pipeline XXV;
starting the high-pressure injection pump (11), pumping low-temperature circulating water in the second water tank (3-2) into the heat exchanger (19), opening the electric valve (5) on the pipeline XXVIII, and after heat exchange, making high-temperature circulating water enter a heat exchange coil in the secondary hydrate decomposition tank (23) through the pipeline XXVIII to provide heat energy for hydrate decomposition and accelerate hydrate decomposition reaction; after heat release is completed, making the low-temperature water return to the second water tank (3-2) through the pipeline XXXII;
repeating the primary CO₂ hydrate decomposition process to conduct secondary purification;
after the hydrate is transported to the secondary hydrate decomposition tank (23), opening the electric valve (5) prior to hydrate decomposition, and opening the electric valve (5) on the pipeline XXIV to recover the high-concentration brine recovered through the pipeline XXIV; opening the electric valve (5) on the pipeline B, starting the vacuum pump (15) on the pipeline XXI, decomposing the purified gas in the secondary hydrate decomposition tank (23), and making the gas flow through the pipeline B to be collected by the vacuum pump (15) into the high-pressure buffer tank (8); after decomposition products flow out, closing the electric valves (5) on all the above mentioned pipelines;
it should be noted that the pipeline C for gas replenishment and pressurization is added to the secondary hydrate decomposition tank (23), i.e. when the electric valve (5) on the pipeline XXIV is opened, opening the first electric valve (5) and the second electric valve (5) on the pipeline XXI through which the gas flowing out of a reactor passes, pumping the high-concentration CO₂ into the secondary hydrate decomposition tank (23) through the pipeline XXI and the pipeline C, and closing the above mentioned valves after pressurization is completed, i.e., after high-concentration seawater flows out completely.

6. A method for realizing CO₂ sequestration by the large-scale integrated device of CO₂ capture, sequestration and utilization according to claim 1, comprising the following steps:
storing the collected CO₂ in the high-pressure buffer tank (8) on the pipeline XXI, opening a third electric valve (5) on the pipeline XXI through which the gas flowing out of the reactor passes to allow CO₂ to be injected into the CO₂ sequestration tank (27), opening the second electric valves (5) on the pipeline XXII and the pipeline XXIII through which hydraulic oil outflow passes to make hydraulic oil enter the axial pressure tracking pump (25) or the peripheral pressure tracking pump (26) to work, and adjusting the working pressure of the pumps according to experimental and engineering requirements; when a target pressure is detected by a pressure sensor (9), opening the third electric valve (5) through which the oil filling pipelines pass, injecting the hydraulic oil into the CO₂ sequestration tank (27) to provide a pressurized environment, and controlling the opening and closing of the first electric valves (5) on the pipeline XXII and the pipeline XXIII through which hydraulic oil outflow passes to adjust the volume of the hydraulic oil in the oil tank (24).
